(19) United States
(12) Patent Application Publication
(10) Pub. No.: US 2016/0093145 A1
(43) Pub. Date: Mar. 31, 2016

(54) GAMING MACHINE FOR PERFORMING FREE GAME TRIGGERED FROM NORMAL GAME AND METHOD OF CONTROLLING THEREOF

(71) Applicants: Universal Entertainment Corporation, Tokyo (JP); Aruze Gaming America, Inc., Las Vegas, NV (US)

(72) Inventors: Kenta KITAMURA, Tokyo (JP); Susumu MIO, Tokyo (JP); Kouhei HASHIMOTO, Tokyo (JP)

(73) Assignees: Universal Entertainment Corporation; Aruze Gaming America, Inc.

(21) Appl. No.: 14/863,390

(22) Filed: Sep. 23, 2015

(30) Foreign Application Priority Data
Sep. 25, 2014 (JP) 2014-195857

(51) Int. Cl. G07F 17/32

(52) U.S. Cl. CPC G07F 17/3213; G07F 17/3267; G07F 17/3286

(57) ABSTRACT

To provide a gaming machine that can achieve higher entertainment properties. When the game transfers from the normal game to the free game, a roulette type selection process is carried out for determining a reference payout value that serves as a basis for the payout awarded when FEATURE symbols are arranged in a display window. In this roulette type selection process, it is determined that any of the fixed payout regions associated with the predetermined payout value or the non-fixed payout regions are stopped. When the fixed payout region is determined to be stopped, the payout value associated with the fixed payout region is awarded. When the non-fixed payout region is determined to be stopped, the mystery payout drawing process in which the awarded payout value is determined at random is additionally performed, and thus the payout value determined through the payout drawing is awarded. Then, the payout value awarded as described above is set as the reference payout value.

### CROSS-REFERENCE TO RELATED APPLICATIONS

This application is based on and claims priority from Japanese application number 2014-195857 filed Sep. 25, 2014, the contents of which are incorporated herein by reference.

### BACKGROUND OF THE INVENTION

### Technical Field

As a gaming machine, a slot machine is generally proposed in which a plurality of symbols are rearranged in a symbol display device every time a player operates a button disposed on a control panel. In such a slot machine, a prize such as a payout is awarded to the player in accordance with the combination of a plurality of symbols rearranged in the symbol display device.

The slot machine disclosed in U.S. Pat. No. 4,097,048 has a wide variety of entertaining effects, displays, and the like such as symbol patterns, game scenarios, sound effects in consideration of a wide variety of player preferences.

As part of efforts to provide variety, U.S. Pat. No. 4,508,345 discloses a slot machine that performs bonus games. Furthermore, U.S. Pat. No. 7,942,733 discloses a slot machine in which the player can enjoy free games under specific conditions.

### CITATION LIST

### Patent Literature

[Patent Literature 1] U.S. Pat. No. 4,097,048

[Patent Literature 2] U.S. Pat. No. 4,508,345

[Patent Literature 3] U.S. Pat. No. 7,942,733

### SUMMARY OF THE INVENTION

### Technical Problem

As described above, the gaming machines try to improve the entertainment properties by offering not only playable normal games but also adding various elements. What element is added to the game is an important matter for the gaming machines to improve the entertainment properties.

Thus, the present invention is intended to provide a gaming machine that can achieve higher entertainment properties.

### Solution to Problem

One aspect of the present invention is a gaming machine for executing a normal game and a free game triggered from the normal game,

the gaming machine comprising:

a display device; and

a controller,

wherein the controller executes the following processes:

(1A) a process of executing the normal game and awarding a prize in accordance with a result of the normal game;

(1B) a process of displaying a roulette having a plurality of fixed payout regions associated with predetermined payout values and a plurality of non-fixed payout regions on the display device when the prize awarded in the process of (1A) is an execution right of the free game;

(1C) a process of performing a roulette type selection that determines at which of the fixed payout region and the non-fixed payout region a mark indicating a winning in the roulette stops;

(1D) a process of awarding, as a result of the roulette type selection,

a payout value associated with the fixed payout region when the region where the mark stops is the fixed payout region, and

a payout value determined through a payout drawing that is carried out for determining the awarded payout value at random when the region where the mark stops is the non-fixed payout region; and

(1E) a process of executing the free game, when a predetermined condition is satisfied as a result of the free game, setting the payout values awarded in the process of (1D) as a reference payout value, and awarding the payout on the basis of the reference payout value.

According to the configuration described above, when the game transfers from the normal game to the free game, the roulette type selection is carried out for determining the reference payout value that serves as a basis for the payout awarded when specific conditions are satisfied in the free game. In this roulette type selection, it is determined that any of the fixed payout regions associated with the predetermined payout value or the non-fixed payout regions are stopped. When the fixed payout region is determined to be stopped, the payout value associated with the fixed payout region is awarded. When the non-fixed payout region is determined to be stopped, the payout drawing in which the awarded payout value is determined at random is additionally performed, and thus the payout value determined through the payout drawing is awarded. Then, the payout value awarded as described above is set as the reference payout value. The reference payout value in the free game is accordingly determined in two-step drawing of the roulette type selection and the payout drawing, and thus the player can enjoy the game with interest in the determination process of the reference payout value and the entertaining effects during the free games.

Or one aspect of the present invention is the gaming machine described above,

wherein the controller

performs the number of roulette type selections depending on the condition when the prize awarded in the process of (1A) is the execution right of the free game and the condition in which a plurality of roulette type selections can be performed is satisfied, and

determines the sum total of the payout values awarded in accordance with the results of the plurality of the roulette type selections in the process of (1E) as the reference payout value and awards the payout based on the reference payout value.

According to the configuration described above, a plurality of roulette type selections can be performed, and the sum total of the payout value awarded in accordance with the results of the plurality of roulette type selections can be set as the reference payout value. Thus, the player can enjoy the game with interest in the result of every roulette type selection.

Or one aspect of the present invention is the gaming machine described above,

wherein the gaming machine

includes a symbol display device for displaying the results of the normal game and the free game by rearranging the plurality of symbols,

wherein the condition in which the plurality of roulette type selections can be performed is rearrangement of the predetermined number of predetermined symbols in the symbol display device as the results of the normal game and the free game, and

the controller executes the number of roulette type selections depending on the number of the predetermined symbols rearranged in the symbol display device.

When the sum total of the payout value awarded in accordance with the results of a plurality of the roulette type selections can be set as the reference payout value, how many times the player can draw the roulette type selection is major concern for the player. According to the configuration described above, the number of roulette type selections depending on the number of predetermined symbols rearranged in the symbol display device are performed, and thus the player can enjoy the game with interest in which kind of symbols are rearranged in the symbol display device.

Or one aspect of the present invention is the gaming described above,

wherein the controller

executes the roulette type selection again when the prize awarded in the free game as a result of the free game is a re-execution right of the free game, adds the payout value awarded as a result of the roulette type selection to the reference payout value, and executes a process to update the reference payout value.

According to the configuration described above, when the prize awarded as a result of the free game is the re-execution right of the free game, the roulette type selection can be carried out again, and furthermore, the payout value awarded as a result can be added to the reference payout value. Thus, the player can enjoy the game with interest in whether the re-execution right of the free game is awarded even in the free games or not.

Or one aspect of the present invention is a gaming machine for executing a normal game and a free game triggered from the normal game,

the gaming machine comprising:

a roulette type selection table that associating region numbers arranged in the roulette, a plurality of fixed payout regions associated with predetermined payout values, a plurality of non-fixed payout regions, and winning rates;

a plurality of payout drawing tables that include different payout values and winning rates;

a storage device for storing a plurality of table codes, the region number corresponding to the plurality of non-fixed payout regions, and a non-fixed payout region transfer table associated with the plurality of payout drawing tables and winning rates;

a display device; and

a controller,

wherein the controller executes the following processes:

(2A) a process of executing the normal game and awarding a prize in accordance with a result of the normal game;

(2B) a process of performing a non-fixed payout region transfer drawing that determines the table code in a drawing in accordance with the non-fixed payout region transfer table and determining the payout drawing table corresponding to the plurality of non-fixed payout regions in accordance with the determined table code, when the prize awarded in the process of (2A) is an execution right of the free game;

(2C) a process of displaying in the display device a roulette in which the region numbers associated with the fixed payout regions and the plurality of non-fixed payout regions are arranged, in accordance with the result of the non-fixed payout region transfer drawing;

(2D) a process of performing a roulette type selection for determining at which of the region numbers a mark indicating a winning in the roulette stops in accordance with the roulette type selection table;

(2E) a process of awarding, as a result of the roulette type selection,

a payout value associated with the fixed payout region when the region number where the mark stops is the fixed payout region, and

a payout value determined through a payout drawing that is carried out for determining the awarded payout value at random in accordance with the payout drawing table corresponding to the non-fixed payout region when the region number where the mark stops is the non-fixed payout region; and

(2F) a process of executing the free game, when a predetermined condition is satisfied as a result of the free game, setting the payout values awarded in the process of (2E) as a reference payout value, and awarding the payout on the basis of the reference payout value.

According to the configuration described above, when the game transfers from the normal game to the free game, the non-fixed payout region transfer drawing that determines the table code in a drawing is performed in accordance with the non-fixed payout region transfer table, and the payout drawing table corresponding to the plurality of non-fixed payout regions can be determined in accordance with the determined table code. A plurality of payout drawing tables that include different payout values and winning rates can be associated with non-fixed payout regions in a drawing, accordingly. Thus, the payout value and winning rate for the non-fixed payout region in the payout drawing are changed each time the game transfers from the normal game to the free game, and the player can enjoy the game with non-uniform payout value and winning rate for the non-fixed payout region and changing each time.

Or one aspect of the present invention is a method of controlling a gaming machine for executing a normal game and a free game triggered from the normal game,

wherein the gaming machine includes:

a display device; and

a controller,

the method of controlling the gaming machine comprising the steps of, wherein the steps are executed through the controller:

(3A) executing the normal game and awarding a prize in accordance with a result of the normal game;

(3B) displaying a roulette having a plurality of fixed payout regions associated with predetermined payout values and a plurality of non-fixed payout regions on the display device when the prize awarded in the step of (3A) is an execution right of the free game;

(3C) performing a roulette type selection that determines at which of the fixed payout region and the non-fixed payout region a mark indicating a winning in the roulette stops;

(3D) awarding, as a result of the roulette type selection,

a payout value associated with the fixed payout region when the region where the mark stops is the fixed payout region, and

a payout value determined through a payout drawing that is carried out for determining the awarded payout value at random when the region where the mark stops is the non-fixed payout region; and

(3E) executing the free game, when a predetermined condition is satisfied as a result of the free game, setting the payout values awarded in the step of (3D) as a reference payout value, and awarding the payout on the basis of the reference payout value.

According to the method described above, when the game transfers from the normal game to the free game, the roulette type selection is carried out for determining the reference payout value that serves as a basis for the payout awarded when specific conditions are satisfied in the free game. In this roulette type selection, it is determined that any of the fixed payout regions associated with the predetermined payout value or the non-fixed payout regions are stopped. When the fixed payout region is determined to be stopped, the payout value associated with the fixed payout region is awarded. When the non-fixed payout region is determined to be stopped, the payout drawing in which the awarded payout value is determined at random is additionally performed, and thus the payout value determined through the payout drawing is awarded. Then, the payout value awarded as described above is set as the reference payout value. The reference payout value in the free game is accordingly determined in two-step drawing of the roulette type selection and the payout drawing, and thus the player can enjoy the game with interest in the determination process of the reference payout value and the entertaining effects during the free games.

### Advantageous Effects of Invention

The present invention can provide a gaming machine that can achieve higher entertainment properties.

### BRIEF DESCRIPTION OF THE DRAWINGS

FIG. 1 is a diagram showing rough schematics of game contents of a slot machine according to an embodiment of the present invention.

FIG. 2 is a diagram showing a functional flow of the slot machine according to an embodiment of the present invention.

FIG. 3 is a diagram showing a game system including slot machines according to an embodiment of the present invention.

FIG. 4 is a diagram showing a general architecture of the slot machine according to an embodiment of the present invention.

FIG. 5 is an illustration diagram showing pay lines of the slot machine according to an embodiment of the present invention.

FIG. 6 is a diagram showing symbol arrays for a normal game in the slot machine according to an embodiment of the present invention.

FIG. 7 is a diagram showing symbol arrays for a free game in the slot machine according to an embodiment of the present invention.

FIG. 8 is an illustration diagram showing reels appeared in a display window of the slot machine according to an embodiment of the present invention.

FIG. 9 is an illustration diagram of details displayed on a liquid crystal display device of the slot machine according to an embodiment of the present invention.

FIG. 10 is a block diagram showing an internal configuration of the slot machine according to the embodiment of the present invention.

FIG. 11 is a diagram showing a symbol combination table of the slot machine according to an embodiment of the present invention.

FIG. 12 is a diagram showing a roulette type selection table of the slot machine according to an embodiment of the present invention.

FIG. 13 is a diagram showing a roulette type selection number association table of the slot machine according to an embodiment of the present invention.

FIG. 14 is a diagram showing a non-fixed payout region transfer table of the slot machine according to an embodiment of the present invention.

FIG. 15A to 15D are diagrams showing a payout drawing table of the slot machine according to an embodiment of the present invention.

FIG. 16 is a diagram showing a flowchart of a main control process in the slot machine according to an embodiment of the present invention.

FIG. 17 is a diagram showing a flowchart of a bet and start check process in the slot machine according to an embodiment of the present invention.

FIG. 18 is a diagram showing a flowchart of a free game process in the slot machine according to an embodiment of the present invention.

FIG. 19 is a diagram showing a flowchart of the FEATURE symbol payout determination process in the slot machine according to the embodiment of the present invention.

FIG. 20 is an illustration diagram of the roulette displayed on an upper image display panel of the slot machine according to an embodiment of the present invention.

FIG. 21 is an illustration diagram of entertaining effect images displayed on the upper image display panel of the slot machine according to an embodiment of the present invention.

FIG. 22 is an illustration diagram showing visual effects on the slot machine and the like in a flowchart form according to an embodiment of the present invention.

FIG. 23 is an illustration diagram showing visual effects on the slot machine and the like in a flowchart form according to an embodiment of the present invention.

FIG. 24 is an illustration diagram showing visual effects on the slot machine and the like in a flowchart form according to an embodiment of the present invention.

FIG. 25 is an illustration diagram showing visual effects on the slot machine and the like in a flowchart form according to an embodiment of the present invention.

FIG. 26 is an illustration diagram showing visual effects on the slot machine and the like in a flowchart form according to an embodiment of the present invention.

FIG. 27 is an illustration diagram showing visual effects on the slot machine and the like in a flowchart form according to an embodiment of the present invention.

FIG. 28 is an illustration diagram showing visual effects on the slot machine and the like in a flowchart form according to an embodiment of the present invention.

FIG. 29 is an illustration diagram showing visual effects on the slot machine and the like in a flowchart form according to an embodiment of the present invention.

FIG. 30 is an illustration diagram showing visual effects on the slot machine and the like in a flowchart form according to an embodiment of the present invention.

FIG. 31 is an illustration diagram showing visual effects on the slot machine and the like in a flowchart form according to an embodiment of the present invention.

FIG. 32 is an illustration diagram of entertaining effect images displayed on the upper image display panel of the slot machine according to an embodiment of the present invention.

FIG. 33 is an illustration diagram of entertaining effect images displayed on the upper image display panel of the slot machine according to an embodiment of the present invention.

FIG. 34 is an illustration diagram of entertaining effect images displayed on the upper image display panel of the slot machine according to an embodiment of the present invention.

FIG. 35 is an illustration diagram of entertaining effect images displayed on the upper image display panel of the slot machine according to an embodiment of the present invention.

FIG. 36 is an illustration diagram of entertaining effect images displayed on the upper image display panel of the slot machine according to an embodiment of the present invention.

FIG. 37 is an illustration diagram of entertaining effect images displayed on the upper image display panel of the slot machine according to an embodiment of the present invention.

FIG. 38 is an illustration diagram of entertaining effect images displayed on the upper image display panel of the slot machine according to an embodiment of the present invention.

FIG. 39 is an illustration diagram of entertaining effect images displayed on the upper image display panel of the slot machine according to an embodiment of the present invention.

FIG. 40 is an illustration diagram of entertaining effect images displayed on the upper image display panel of the slot machine according to an embodiment of the present invention.

FIG. 41 is an illustration diagram of entertaining effect images displayed on the upper image display panel of the slot machine according to an embodiment of the present invention.

FIG. 42 is an illustration diagram of entertaining effect images displayed on the upper image display panel of the slot machine according to an embodiment of the present invention.

FIG. 43 is an illustration diagram of entertaining effect images displayed on the upper image display panel of the slot machine according to an embodiment of the present invention.

FIG. 44 is an illustration diagram of entertaining effect images displayed on the upper image display panel of the slot machine according to an embodiment of the present invention.

FIG. 45A to 45C are illustration diagrams of entertaining effect images displayed on the upper image display panel of the slot machine according to an embodiment of the present invention.

FIG. 46 is an illustration diagram of entertaining effect images displayed on the upper image display panel of the slot machine according to an embodiment of the present invention.

FIG. 47 is an illustration diagram of entertaining effect images displayed on the upper image display panel of the slot machine according to an embodiment of the present invention.

FIG. 48 is an illustration diagram of entertaining effect images displayed on the upper image display panel of the slot machine according to an embodiment of the present invention.

FIG. 49 is an illustration diagram of entertaining effect images displayed on the upper image display panel of the slot machine according to an embodiment of the present invention.

### DETAILED DESCRIPTION OF THE PREFERRED EMBODIMENTS

### Summary of the Invention

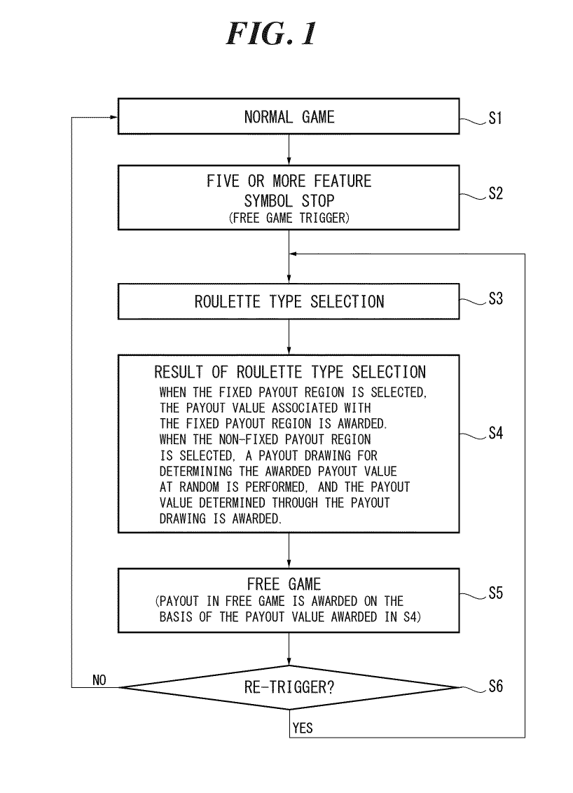

Hereinafter, embodiments of the present invention will be described with reference to accompanying drawings. FIG. 1 is a diagram showing rough schematics of a game flow of a slot machine according to an embodiment of the present invention. As shown in FIG. 1, the slot machine according to the embodiment of the present invention processes slot games including game modes of normal games and free games which are transferred from the normal games.

A slot game is a line type game (Left to Right type: with scatter symbols in a part of games). The slot game uses mechanical reels. There are five reels in a machine. That is to say, the reels include a first reel, a second reel, a third reel, a fourth reel, and a fifth reel. A display window 150 has thirty pay lines determined thereon.

In the normal game, the process is carried out in which a plurality of symbols indicated on five reels, which are rearranged in the display window, are selected in a drawing, the selected symbols are rearranged in the display window, and a prize is awarded on the basis of a combination of symbols rearranged on the pay line (S1).

Next, if the awarded prize is an execution right of the free games (free game trigger), which is granted when five or more FEATURE symbols are rearranged in the display window (S2), a roulette type selection is performed (S3). In this roulette type selection, a display device first displays a roulette having a plurality of fixed payout regions associated with predetermined payout values and a plurality of non-fixed payout regions.

Then, the roulette type selection is performed for determining at which of the fixed payout region and the non-fixed payout region the mark indicating the winning in the roulette stops (S3).

As a result of the roulette type selection, when the mark stops at the fixed payout region, the payout values associated with the fixed payout region at which the mark stops are awarded. When the mark stops at the non-fixed payout region, a payout drawing is performed for determining the winning payout values at random, and the payout values determined by the payout drawing is awarded (S4).

Then, the free games are executed, and when the predetermined conditions are fulfilled as a result of the free game, the payout values awarded in the process (S4) is set as a reference payout value, and the payout on the basis of the reference payout value is awarded (S5).

### DEFINITIONS

In this embodiment, a slot machine 1 is described as one example of gaming machines; however, the slot machine 1 is not limited to those gaming machines but may be an apparatus that can execute any type of normal games independently and can also execute the free games that are triggered from the normal games

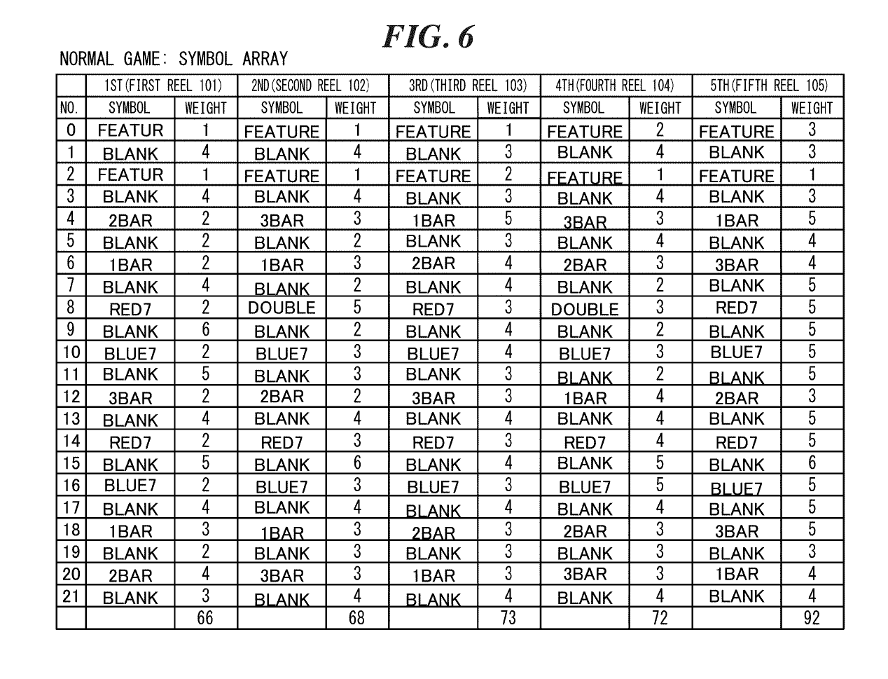

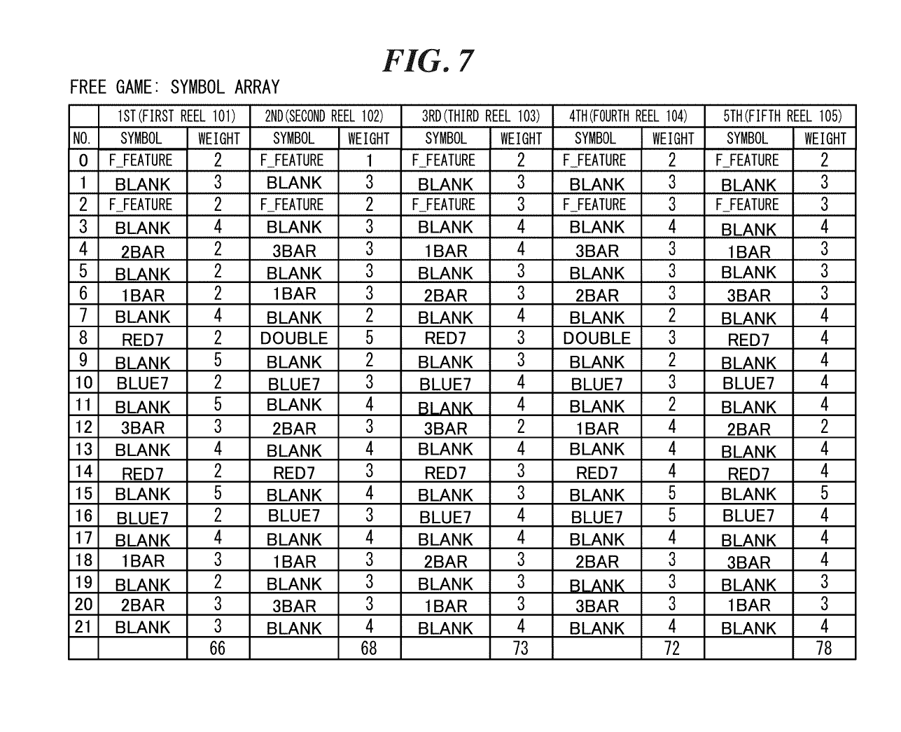

The normal games in this embodiment are executed by the slot machine 1. A normal game is a slot game in which a plurality of symbols (see FIG. 6 and other drawings) are rearranged. The rearrangement of the symbols in the slot game is performed with mechanical reel devices (corresponding to a display device and a symbol display device). The normal game is a game in which the symbols are rearranged in the display window with the mechanical reel devices under a condition of placing bets of playing cost and the payout associated with the rearranged symbols is awarded. In other words, the normal game refers to a game that is started on the condition that the playing cost is consumed. On the other hand, a free game in this embodiment is a slot game in which a plurality of symbols (see FIG. 7 and other drawings) are rearranged in a similar manner to the normal game. The free game is a game that is executable with a smaller amount of bets of playing cost than that in the normal game (the term ‘(a game) executable with a smaller amount of bets of playing cost’ includes a case where the bet is “0”.) The ‘free game’ in this embodiment is a game that is executed without the condition of placing bets of playing cost. In other words, the ‘free game’ refers to a game that is started without the condition that the playing cost is consumed.

The symbols refer to a general term for “RED7”, “BLUE7”, “3BAR”, “2BAR”, “1BAR”, “DOUBLE”, “BLANK”, and “FEATURE”.

The playing cost is electronic valuable information such as electronic money. The playing cost in the present invention is not limited in particular and may be game media such as coins, medals, tokens, and tickets, for example. The ticket is not limited in particular and may be a ticket with a bar code in which data such as the number of credits are encoded, for example. Furthermore, the ‘playing cost’ may be game points including no valuable information.

Rearrangement refers to the state where the arrangement of the symbols is cleared and then the symbols are arranged again. The arrangement refers to the state where the symbols can be recognized visually by a player in the outside of the machine. Specifically, the rearrangement is the state where the symbols on the reels are changed and displayed in connection with the spins of reels, then the spins of reels stop to stop the changing display of symbols, and thus the symbols stop to appear in the display window.

(Description of Functional Flow Chart)

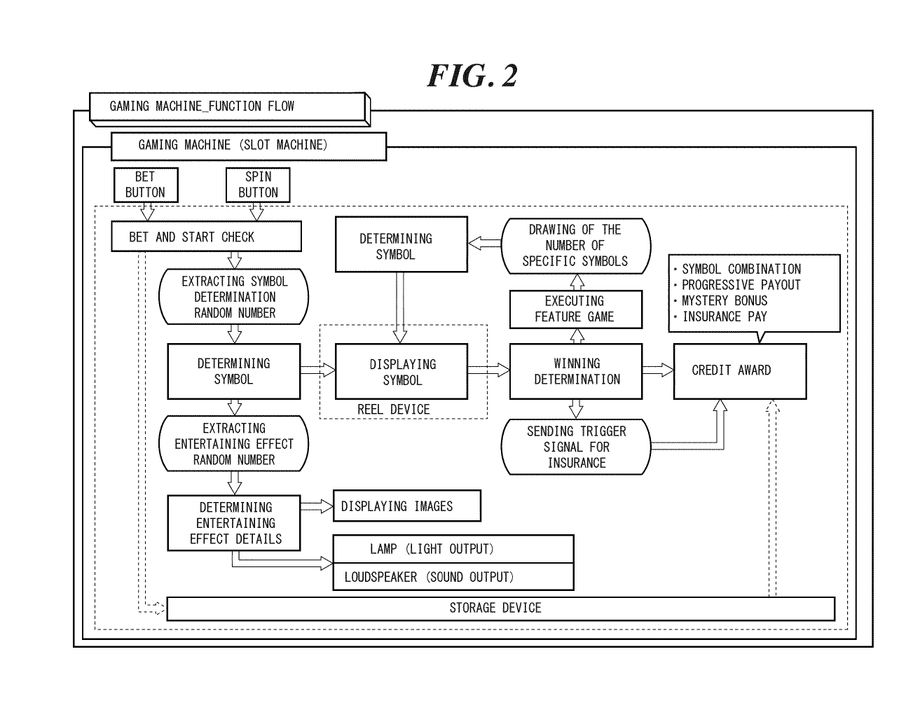

With reference to FIG. 2, a basic function of the slot machine according to an embodiment of the present invention is described. FIG. 2 is a diagram showing a functional flow of the slot machine according to the embodiment of the present invention.

<Bet and start check> First, the slot machine checks whether a BET button is pressed by a player or not and then checks whether a spin button is pressed by the player or not.

<Symbol determination> Next, the slot machine draws a symbol determination random number once the spin button is pressed by the player and determines each symbol to be displayed (rearranged) to the player with respect to each of the reels when the spins of reels stop.

(Reel Control)

The slot machine then controls to start the spin of each reel and to stop each reel spin so as to display the determined symbols to the player.

<Prize winning determination> The slot machine then determines whether a combination of the symbols displayed to the player matches a winning combination for a prize or not when the spin of each reel stops.

<Prize awarding> If the combination of the symbols displayed to the player matches the winning combination for a prize, the slot machine then awards the prize depending upon the type of the combination of symbols to the player. For example, when the combination of symbols matching with an award of credits is displayed, the slot machine awards the number of credits according to the combination of symbols to the player.

In addition, the slot machine may accumulate and add a part of placed bet amounts to multiple types of progressive payouts stored in a storage device at each unit game.

The slot machine starts the free game when the combination of symbols matching with the free game trigger is displayed. In the embodiments of the present invention, the game (free game) is performed in which a selection in a drawing relating to the determination of symbols to be stopped as described above is made in predetermined times without the consumption of playing costs as the free game.

The slot machine may pay out the amount of coins in a jackpot to the player when the combination of symbols matching with a jackpot trigger is displayed. The jackpot refers to a feature in which a part of coins consumed by the player in each slot machine is accumulated as the amount of jackpot, and the coins corresponding to the accumulated amount of jackpot are paid out from the slot machine when one of slot machines wins the jackpot trigger. In this case, the slot machine calculates an amount (accumulated amount) accumulated as the amount of jackpot in each unit game and transmits the accumulated amount to the external control device. The external control device accumulates the accumulated amount transmitted from each slot machine to the amount of jackpot.

The slot machine may include prizes such as a mystery bonus and an insurance in addition to the aforementioned prize. The mystery bonus is a feature in which the predetermined amount of coins is paid out when a special drawing is selected. When a spin button is pressed, the slot machine extracts a random number for a mystery bonus and determines in a drawing whether a mystery bonus trigger will be established or not.

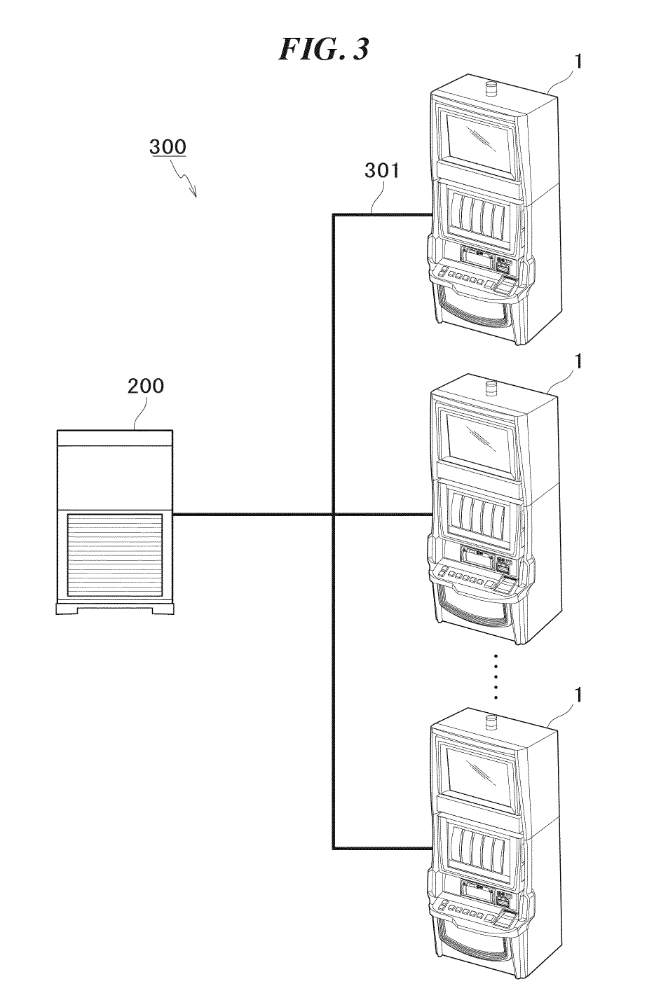

The insurance is a feature that is provided to intend to relieve the player from the situation in which the free game is not played for long periods. In the embodiment of the present invention, the administrator of slot machines can select whether enabling the insurance or not at his or her option. When the insurance is enabled, the predetermined amount of insurance participation is traded off. The slot machine starts counting of the number of games when the insurance becomes enabled. When the number of games counted reaches the predetermined number without a large amount of payouts by the free games or other games, the slot machine pays out the amount of coins set for the insurance.

<Determination of entertaining effects> The slot machine gives the entertaining effects through the display of images by a display, an optical output by a light, and a sound output by a loudspeaker. The slot machine extracts a random number for the entertaining effects and determines the details of entertaining effects in accordance with the symbols and the like determined in a drawing.

[Entire Game System] Basic functions of the slot machine have been described so far. Next, with reference to FIG. 3, a game system including the slot machine will be described. FIG. 3 is a diagram showing a game system including slot machines according to an embodiment of the present invention.

A game system 300 includes a plurality of slot machines 1 and an external control device 200 connected to each of the slot machines 1 through a communication line 301.

The external control device 200 controls a plurality of slot machines 1. In the embodiment of the present invention, the external control device 200 is commonly known as a hall server provided in a game facility where a plurality of slot machines 1 are provided. Each of the slot machines 1 has a unique identification number, and the external control device 200 determines the source of data sent from the slot machines 1 on the basis of the identification number. Also when data is transmitted from the external control device 200 to the slot machine 1, the identification number is used to specify the transmission destination.

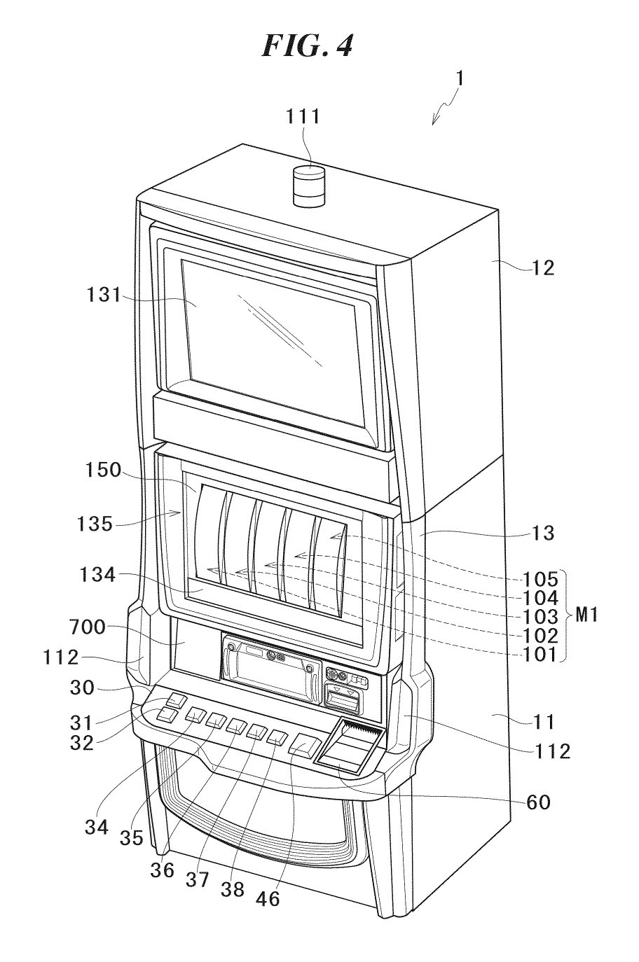

The game system 300 may be constructed in a single game facility where various games, such as casino games, are playable, or may be constructed between a plurality of game facilities. When constructed in a single game facility, the game system 300 may be constructed in each floor or section of the game facility. The communication line 301 may be wired or wireless, and a dedicated line or a switched line may be used.

[General Architecture of Slot Machine] Next, with reference to FIG. 4, a general architecture of the slot machine 1 will be described. FIG. 4 is a diagram showing a general architecture of the slot machine according to the embodiment of the present invention.

The slot machine 1 uses electronic valuable information such as electronic money as the playing cost. The playing cost is not limited to those and may be game media such as coins, medals, tokens, and tickets with the bar code, for example.

The slot machine 1 includes a cabinet 11, a top box 12 provided at the top of the cabinet 11, and a main door 13 provided on the front surface of the cabinet 11. A lamp 111 is also provided on the cabinet 11.

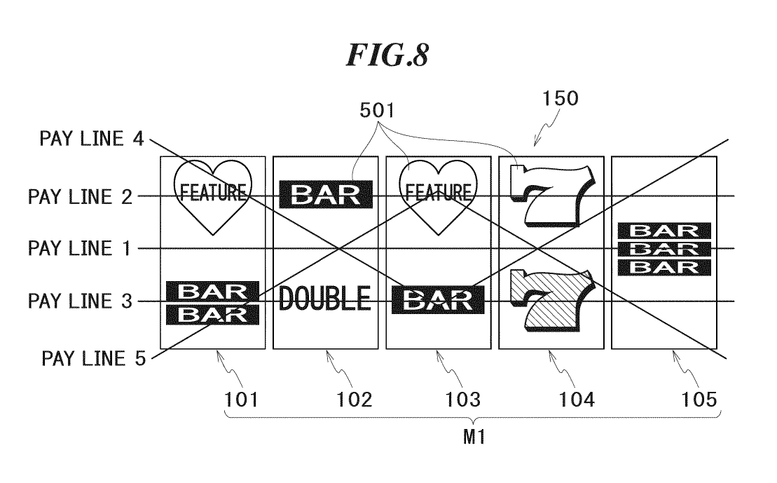

The main door 13 is provided with a reel device M1 (corresponding to the display device) including five reels 101, 102, 103, 104, and 105. A reel cover 135 is provided on the front surface of the reel device M1. A liquid crystal display device 134 and a transparent panel for displaying game situations to the player are provided on the front surface of the reel cover 135. The liquid crystal display device 134 includes a touch panel 137. The reel cover 135 has the display window 150 in a central portion. The display window 150 displays one symbol 501 (see FIG. 8) in each of three regions of an upper, a middle, and a lower row depending on the respective reels 101 to 105. In other words, fifteen symbols 501 in a total of five columns and three rows are visibly displayed on the display window 150. In addition, twenty-two symbols are depicted on an outer periphery of each reel 101, 102, 103, 104, or 105 (see FIG. 6, FIG. 7). These twenty-two symbols 501 are arranged in series along the rotation direction of the reel 101, 102, 103, 104, or 105 and form a symbol line. The symbol line is configured in combination of “RED7”, “BLUE7”, “3BAR”, “2BAR”, “1BAR”, “DOUBLE”, “BLANK”, and “FEATURE”. The main door 13 is also provided with loudspeakers 112.

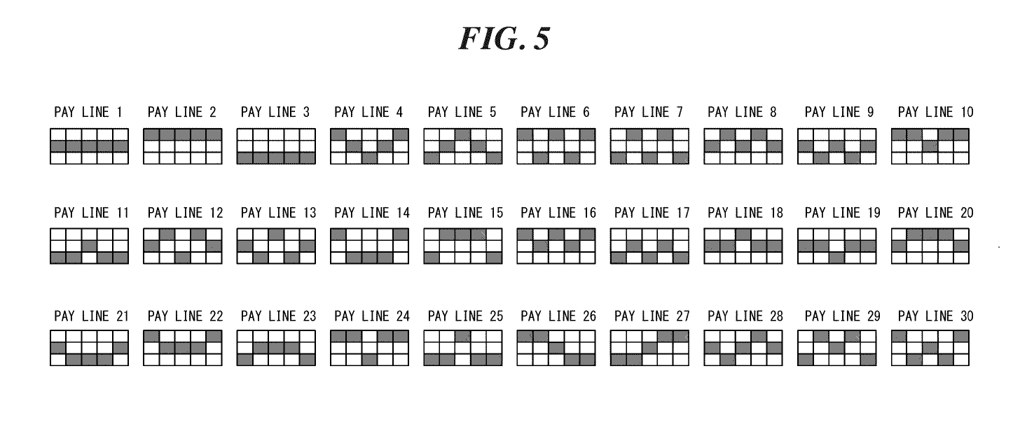

Pay lines as shown in FIG. 5 are set in the slot machine 1 for determining the prize winning of the symbols 501 rearranged in the display window 150. In this embodiment, as shown in FIG. 5, thirty pay lines 1 to 30 are formed in total. In this embodiment, all thirty pay lines are equally enabled regardless of the amount of bets when a game is executed. This embodiment may be configured such that each pay line can be enabled in response to the choice of the player. In the following descriptions, the prize winning by a pay line form may refer to a line prize winning and the prize winning by a scatter form may refer to a scatter prize winning in some cases.

As shown in FIG. 8, the reel device M1 (corresponding to the symbol display device) rearranges the symbols 501 in the display window 150 by driving to rotate the reels 101, 102, 103, 104, and 105 where the symbols 501 are indicated on the outer peripheries. In the following descriptions, the reels are also referred to as the first reel 101, the second reel 102, the third reel 103, the fourth reel 104, and the fifth reel 105 in the order from the left side facing from the front.

A Backlight device (not shown) is provided on each of inner peripheral sides of the reels 101, 102, 103, 104, and 105 configured as described above. The backlight device is disposed such that illuminating light is emitted from the inner peripheral side of the reel 101, 102, 103, 104, or 105 to the direction of the outer periphery of the reel and the illuminating light passing through the outer periphery of the reel can be recognized visually from the outside of the display window 150. The backlight device is made to the specification such that the light quantity during the emission of the illuminating light can be changed in multiple levels and enables to increase a degree of flexibility of the entertaining effects using the illuminating light. In addition, each of the backlight devices is able to emit light in multiple colors and illuminates each symbol with the illuminating light.

In this embodiment, although a case where the slot machine 1 includes the mechanical reel-type reel device M1 is described, the slot machine 1 of the present invention may include a video reel type that displays pseudo reels or mixedly include the video reel type and a mechanical reel type.

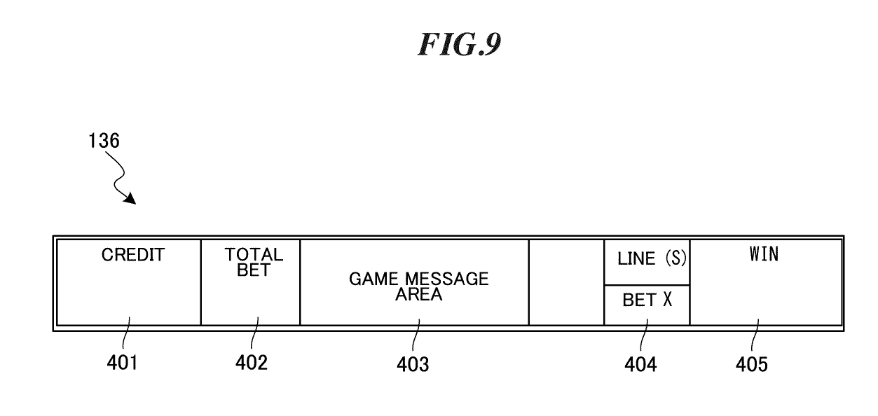

The liquid crystal display device 134 displays, as shown in FIG. 9, a meter for displaying the situation of the game. For example, a credit meter 401 displays the total amount of credits in the current situation. The initial value is zero. The value increases or decreases, depending on the insertion of playing cost, bets, and the result of games. A total bet meter 402 displays the “total bet (=bet×line)”. The values are recalculated for each game play. A game message area 403 displays the message that explains the current game situation. A line-bet meter 404 displays the number of bet pay lines and the amount of bets. A win meter 405 incrementally displays the total credits of winning prizes.

On the front surface of the top box 12, an upper image display panel 131 is provided. The upper image display panel 131 has a liquid crystal panel and configures a display. The upper image display panel 131 displays images related to effects or images representing description of contents and rules of a game.

A control panel 30 where various buttons are arranged, a PTS device 700, and a bill entry 60 are provided below the reel device M1.

The bill entry 60 is configured to verify the acceptability of inserted bills and accept the regular bills in the cabinet 11. The bill entry 60 is electrically connected to the PTS device 700 and transmits an input signal according to the amount of the inserted bill to the PTS device 700 when accepting the regular bill. The input signal includes information such as credit data with respect to the accepted bill.

The PTS device 700 is a unit in combination of an LCD (liquid crystal display), a human body detection camera, a microphone, and other components. The human body detection camera can detect the presence or absence of a player with a camera function. The microphone is used to allow the player to participate in a game by voice or to authenticate the player through voice recognition. The PTS device 700 also includes a card insertion slot where an IC card can be inserted. Thus, the player can insert the IC card into the card insertion slot to use the credits stored in the IC card on the slot machine 1.

(Control Panel 30) The control panel 30 includes a HELP button 31 and a CASH-OUT button 32 arranged in a left region facing the front of the machine, a 30-BET button 34, a 60-BET button 35, a 90-BET button 36, a 120-BET button 37, and a 150-BET button 38 arranged in a center region, and a spin button 46 arranged in a right region facing the front of the machine.

The HELP button 31 is a button pushed when the operation procedure of the game etc. is unclear. When the HELP button 31 is pushed, various types of help information are displayed on the upper image display panel 131. The CASH-OUT button 32 is an operation button used when the credits stored in the slot machine 1 are cashed in.

The 30-BET button 34 is a button in which thirty credits possessed by the player at that time are bet each time when the button is pushed once. The 60-BET button 35 is a button for starting the game with sixty bets. The 90-BET button 36 is a button for starting the game with ninety bets. The 120-BET button 37 is a button for starting the game with one hundred and twenty bets. The 150-BET button 38 is a button for starting the game with one hundred and fifty bets. In this embodiment, thirty bets are required as a minimum bet for stating a normal game, and all thirty pay lines 1 to 30 are equally enabled.

The spin button 46 is a button used in the start of scrolling of the reels 101, 102, 103, 104, and 105.

(Symbol Array) Next, with reference to FIG. 6 and FIG. 7, the arrangement of the symbols 501 included in the first reel 101, the second reel 102, the third reel 103, the fourth reel 104, and the fifth reel 105 of the slot machine 1 will be described. FIG. 6 shows symbol arrays that are used in a normal game. FIG. 7 shows symbol arrays that are used in a free game.

The symbol tables shown in FIG. 6 and FIG. 7 show the arrangements of the symbols 501 displayed on the outer peripheries of the reels. The symbol lines formed with twenty-two symbols 501 corresponding to code numbers “0” to “21” are allocated to each of the first reel 101, the second reel 102, the third reel 103, the fourth reel 104, and the fifth reel 105.

As shown in FIG. 6 and FIG. 7, the types of symbols include “RED7”, “BLUE7”, “3BAR”, “2BAR”, “1BAR”, “DOUBLE”, “BLANK”, and “FEATURE” (“F#FEATURE” in a free game). Two “FEATURE” (“F#FEATURE”) symbols are provided in each reel 101 to 105, and ten “FEATURE” (“F#FEATURE”) symbols are provided in total. In addition, the “FEATURE” (“F#FEATURE”) is a symbol that is required to satisfy the trigger (re-trigger) of the free game.

As shown in FIG. 6 and FIG. 7, weight values associated with the normal games and the free games are set to twenty-two symbols corresponding to the respective code numbers “0” to “21”. These weight values are probability values in which the corresponding symbols 501 are rearranged in the middle row of the display window 150. For example, as shown in FIG. 6, the “FEATURE” corresponding to the code number “0” of the first reel 101 is rearranged in the middle row of the display window 150 with the probability of 1/66. In addition, the “3BAR” corresponding to the code number “4” of the second reel 102 is rearranged in the middle row of the display window 150 with the probability of 3/68.

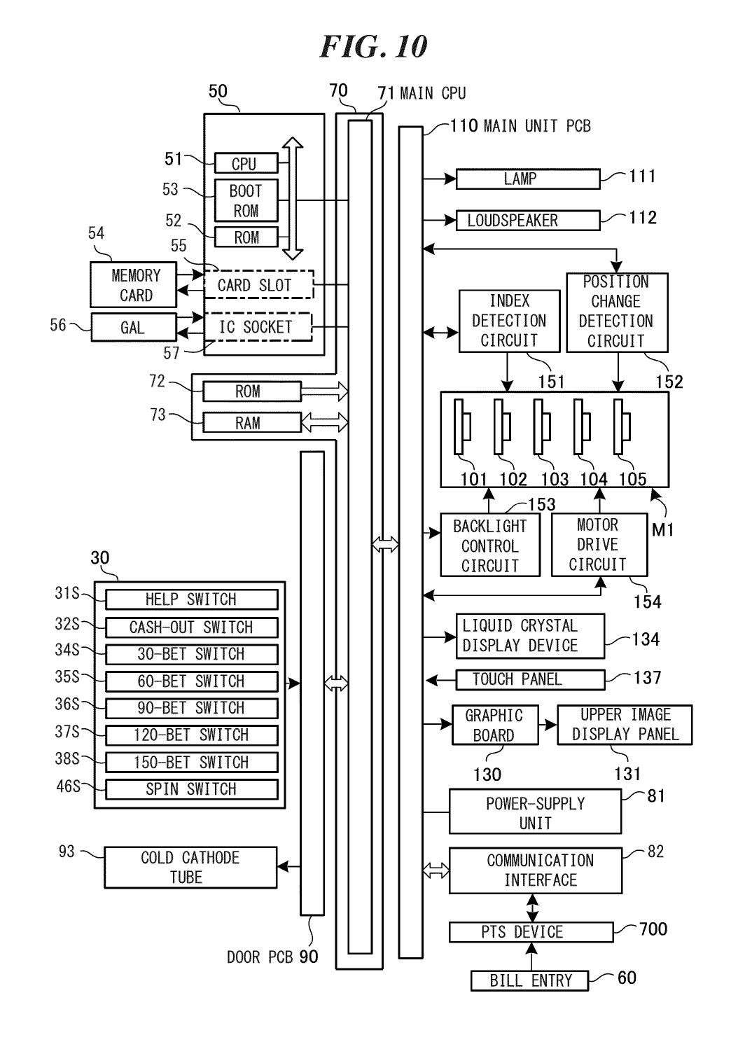

In the free game, the symbol table shown in FIG. 7 is used, and the weight values associated with the free games are set that are different from the weight associated with the normal games shown in FIG. 6.

[Circuit Architecture provided in Slot Machine] Next, with reference to FIG. 10, a circuit architecture provided in the slot machine 1 will be described. FIG. 10 is a block diagram showing an internal configuration of the slot machine according to the embodiment of the present invention.

A gaming board 50 includes a CPU 51, a ROM 52, and a boot ROM 53 that are connected to each other through an internal bus, a card slot 55 provided for a memory card 54, and an IC socket 57 provided for GAL (Generic Array Logic) 56.

The memory card 54 includes a nonvolatile memory and stores a game program. The game program includes a program relating to game sequence and an entertaining effect program for producing the effects by images or sounds.

The card slot 55 is configured to allow the memory card 54 to be inserted or removed and connected to a motherboard 70 through an IDE bus. Thus, the kind or content of the game which is executed on the slot machine 1 may be changed by withdrawing the memory card 54 from the card slot 55, writing a different game program into the memory card 54, and inserting the memory card 54 into the card slot 55.

The GAL 56 is a kind of PLD (Programmable Logic Device) having an OR fixed-type array structure. The GAL 56 includes a plurality of input ports and output ports. When the GAL 56 receives a specified input in the input port, the GAL outputs the relating data from the output port.

The IC socket 57 is configured to allow the GAL 56 to be attached or detached and connected to the motherboard 70 through a PCI bus. The content of the game which is executed on the slot machine 1 may be changed by replacing the memory card 54 in which a different program is written or rewriting the program stored in the memory card 54 to a different game program.

The CPU 51, the ROM 52, and the boot ROM 53 that are connected to each other through the internal bus are connected to the motherboard 70 through the PCI bus. The PCI bus transmits the signals between the motherboard 70 and the gaming board 50 and also supplies electrical power from the motherboard 70 to the gaming board 50.

The ROM 52 stores an authentication program. The boot ROM 53 stores a preliminary authentication program, a program (boot code) in which the CPU 51 activates the preliminary authentication program, or the like. The authentication program is a program (falsification check program) which authenticates the game program. The preliminary authentication program is a program which authenticates the aforementioned authentication program. The authentication program and the preliminary authentication program are written along procedures (authentication procedure) which authenticates that a target program is not falsified.

The motherboard 70 includes a main CPU 71, a ROM 72, a RAM 73, and a communication interface 82. The ROM 72 and the RAM 73 correspond to the storage device.

The ROM 72 is constructed from a memory device such as a flash memory and stores a program such as BIOS executed by the main CPU 71 and permanent data. When the main CPU 71 executes the BIOS, initializing processes for predetermined peripheral devices are conducted. In addition, retrieving processes of a game program stored in the memory card 54 are initiated through the gaming board 50.

The processor in the present invention is configured to include the main CPU 71, the ROM 72, the RAM 73, and the memory card 54 storing the game program and to control the slot machine by executing the game program with the main CPU 71. It should be understood that the processor is not limited to such a configuration described above and may employ the configuration that stores the game program in the ROM 72 instead of the memory card 54.

The RAM 73 stores the data or the program used when the main CPU 71 operates. For example, when the retrieving process of the game program or the authentication program described above is performed, these programs can be stored. In addition, working areas are allocated in the RAM 73 when the aforementioned program is executed. For example, an area for storing the number of plays, the amount of bets, the number of awarded credits, the payout values for progressive payouts, etc., an area for storing symbols (code number) determined in a drawing, and the like are allocated (for example, a number-of-awarded-credits storage area, a total-credits storage area for free game, a number-of-credits storage area, a reference payout value storage area, and a number-of-awarded-credits storage area for free game).

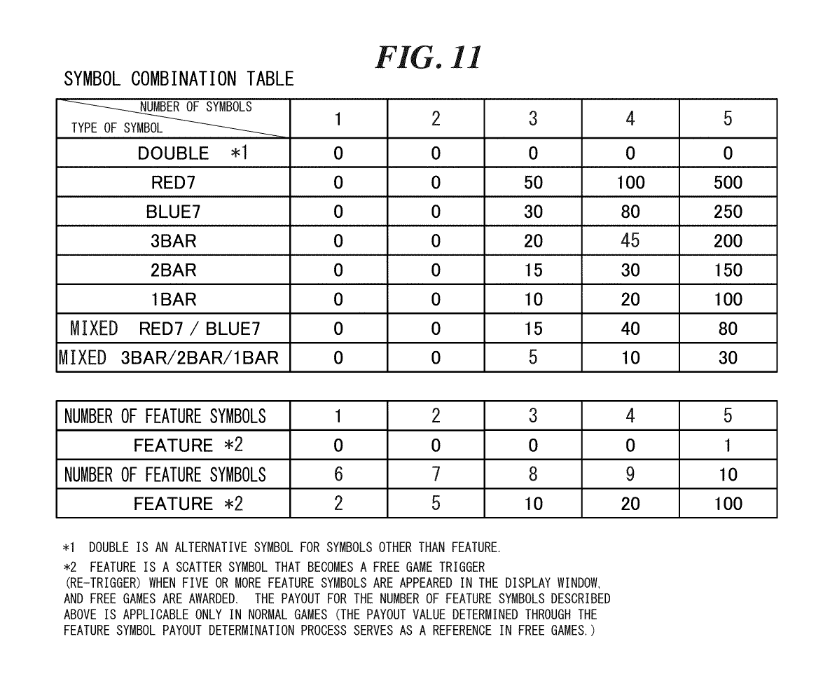

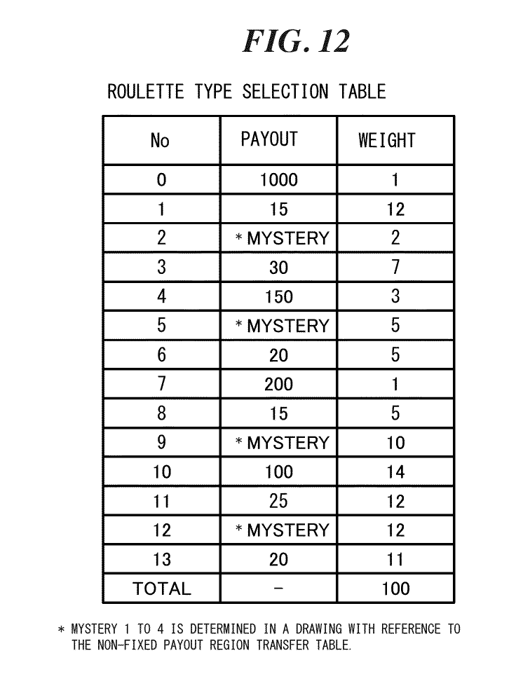

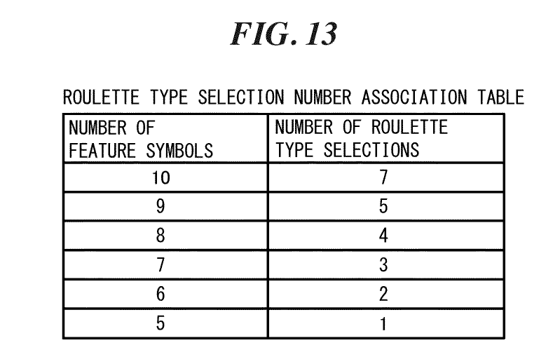

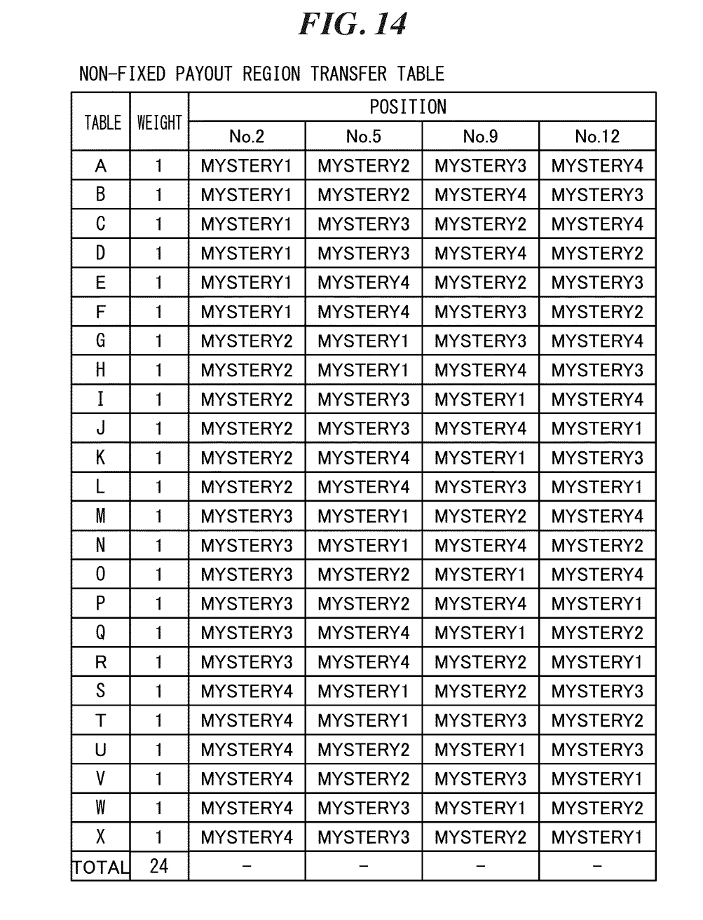

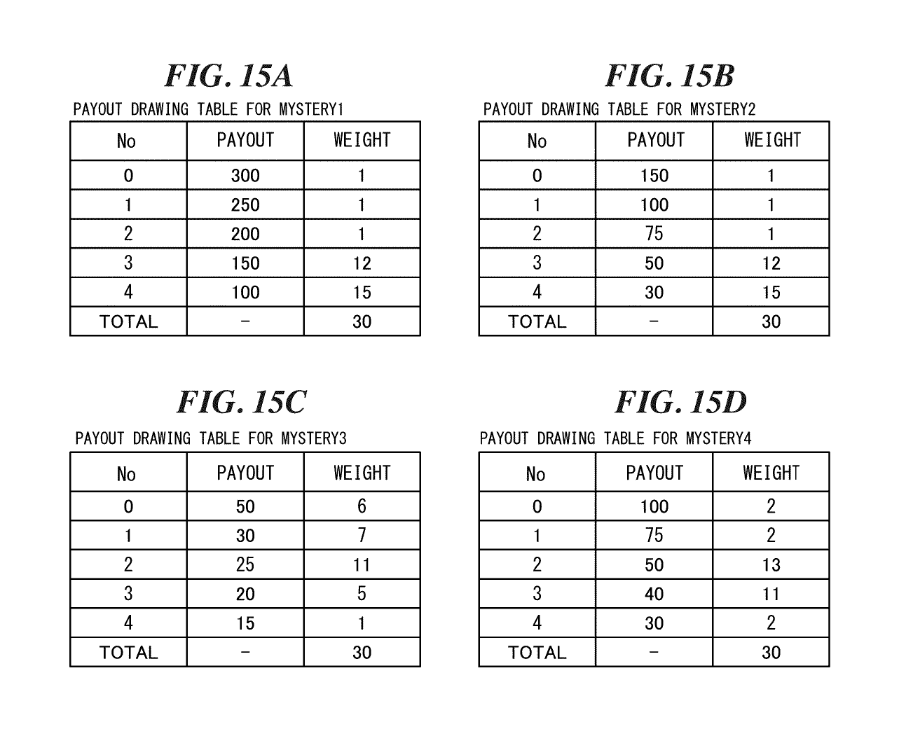

In addition, the RAM 73 stores various tables such as a symbol combination table (see FIG. 11), a roulette type selection table (see FIG. 12), a roulette type selection number association table (see FIG. 13), a non-fixed payout region transfer table (see FIG. 14), and payout drawing tables for MYSTERY1 to 4 (see FIG. 15A to 15D).

The communication interface 82 is configured to communicate with the PTS device 700 and the external control device 200. The PTS device 700 transmits the credit data included in the input signal to the main CPU 71 through the communication interface 82 when receiving the input signal from the bill entry 60. The PTS device 700 also transmits the credit data stored in the IC card to the main CPU 71 through the communication interface 82 when the IC card is inserted into the card insertion slot. In addition, the PTS device 700 writes the credit data into the IC card inserted in the card insertion slot in accordance with the control signal received from the main CPU 71 through the communication interface 82.

The motherboard 70 is connected to both of a door PCB (Printed Circuit Board) 90 and a main unit PCB 110 described below through the USB. In addition, the motherboard 70 is connected to a power-supply unit 81. When electrical power is supplied from the power-supply unit 81 to the motherboard 70, the main CPU 71 on the motherboard 70 is activated, and the power is also supplied to the gaming board 50 through the PCI bus to activate the CPU 51.

The door PCB 90 and the main unit PCB 110 are connected to input devices such as switches and sensors and peripheral devices of which the operation is controlled by the main CPU 71. The door PCB 90 is connected to a control panel 30 and a cold cathode tube 93.

The control panel 30 includes a HELP switch 31S, a CASH-OUT switch 32S, a 30-BET switch 34S, a 60-BET switch 35S, a 90-BET switch 36S, a 120-BET switch 37S, a 150-BET switch 38, and a spin switch 46S corresponding to the respective buttons described above. Each of the switches detects that each of the corresponding buttons is pressed by the player, and outputs signals to the main CPU 71.

The cold cathode tube 93 is configured to function as a backlight disposed on a back side of the upper image display panel 131 and turned on in accordance with a control signal output from the main CPU 71.

The main unit PCB 110 is connected to the lamp 111, the loudspeaker 112, a graphic board 130, a liquid crystal display device 134, the touch panel 137, an index detection circuit 151, a position change detection circuit 152, a backlight control circuit 153, and a motor drive circuit 154. In addition, the index detection circuit 151, the position change detection circuit 152, the backlight control circuit 153, and the motor drive circuit 154 are connected to the reel device M1.

The lamp 111 is turned on in accordance with the control signal output from the main CPU 71. The loudspeaker 112 outputs sound, such as BGM, in accordance with the control signal output from the main CPU 71.

The graphic board 130 controls the display of images on the upper image display panel 131 in accordance with the control signal output from the main CPU 71. The graphic board 130 includes a VDP (Video Display Processor) for producing image data, a video RAM for storing the image data produced by the VDP, and the like. The image data used during the production of the image data by the VDP is included in the game program that is read from the memory card 54 and stored in the RAM 73.

The liquid crystal display device 134 displays the images in accordance with the control signal output from the main CPU 71. The touch panel 137 detects the position where the finger of the player or the like touches on the liquid crystal display device 134 and outputs the signal corresponding to the detected position to the main CPU 71.

The motor drive circuit 154 is connected to stepping motors for rotating the reels 101, 102, 103, 104, and 105. The motor drive circuit 154 includes a FPGA (Field Programmable Gate Array) and a driver. The FPGA is a programmable electronic circuit such as an LSI and functions as a control circuit of a stepping motor. The driver functions as an amplifier circuit of pulses input to the stepping motor.

The index detection circuit 151 is configured to detect the position of the reels 101, 102, 103, 104, and 105 during the rotation and can detect the loss of synchronization of the reels 101, 102, 103, 104, and 105.

The position change detection circuit 152 detects the change of the stopping positions of the reels 101, 102, 103, 104, and 105 after the rotations of the reels 101, 102, 103, 104, and 105 stop. For example, when the stopping positions are changed to match the winning combination of the symbols 501 by an external action such as fraud despite the fact that the combination of the symbols 501 does not match the winning combination, the position change detection circuit 152 detects the change of the stopping positions of the reels 101, 102, 103, 104, and 105. The position change detection circuit 152 is configured to be capable of detecting the change of the stopping positions of the reels 101, 102, 103, 104, and 105 by detecting, for example, fins (not shown) attached to the inner sections of the reels 101, 102, 103, 104, and 105 at predetermined intervals.

The excitation system of the stepping motor is not limited specifically and may employ a 1-2-phase excitation system or a 2-phase excitation system. In addition, in place of the stepping motor, a DC motor may be employed. When the DC motor is employed, the main unit PCB 110 is connected to a deviation counter, a D/A converter, and a servo amplifier in order, and the DC motor is connected to the servo amplifier. The rotational position of the DC motor is detected by a rotary encoder, and the current rotational position of the DC motor is supplied as data from the rotary encoder to the deviation counter.

The backlight control circuit 153 is connected so as to supply driving power to the individual backlight device. The backlight control circuit 153 receives commands from the main CPU 71 and can control to change the light quantity in multiple levels when illuminating light is emitted. In addition, five backlight devices provided in the inner peripheries of the reels 101, 102, 103, 104, and 105 can individually emit illuminating light to fifteen symbols 501 stopped in the display window 150 through the backlight control circuit 153.

### (Configuration of Symbol Combination Table)

Next, the symbol combination table is described with reference to FIG. 11. FIG. 11 shows the symbol combination table in a normal game and a free game on the slot machine according to an embodiment of the present invention.

The symbol combination table in the normal game and the free game defines the payouts for the winning combination of the symbols. In the slot machine 1, the winning is achieved when the scroll of each reel 101 to 105 stops and the combination of the symbols appearing on effective pay lines 1 to 30 (see FIG. 5) matches the winning combination of the symbols defined on the symbol combination table. Then, the prize such as the payout or the start of a free game is awarded to the player in accordance with the winning. When the combination of the symbols appearing on the pay lines 1 to 30 fails to match any of the winning combination of the symbols defined on the symbol combination table, the winning is not achieved (or that is commonly known as losing the game).

Basically, when three symbols, four symbols, or five symbols of the types of symbols “RED7”, “BLUE7”, “3BAR”, “2BAR”, “1BAR” appear on the effective pay lines 1 to 30, the winning is achieved. When the mixed combination of symbols “RED7” and “BLUE7” appears, the winning is achieved as the ‘Mixed RED7/BLUE7’ (see FIG. 11). When the mixed combination of symbols “3BAR”, “2BAR”, “1BAR” appears, the winning is achieved as the ‘Mixed 3BAR/2BAR/1BAR’.

In addition, the “DOUBLE” is an alternative symbol for symbols other than the “FEATURE” (in this embodiment, the “DOUBLE” symbol is arranged in the second reel 102 and the fourth reel 104). When the combination of symbols including the “DOUBLE” appears on the pay line 1 to 30 and thus the winning is achieved, one “DOUBLE” symbol included in the combination doubles the payout for the achieved winning, and two “DOUBLE” symbol included in the combination quadruples the payout for the achieved winning. For example, if three “3BAR” symbols appear on the pay line, 20 payouts are awarded in a normal case (FIG. 11). In contrast, if one “DOUBLE” and three “3BAR” symbols appear on the pay line, 40 payouts which is the double of 20 payouts are awarded.

The “FEATURE” symbol is a scatter symbol that triggers the free game. Specifically, when five or more “FEATURE” symbols are appeared on any places in the display window 150, some payouts are awarded as scatter pay. Furthermore, when five or more “FEATURE” symbols are appeared on any places in the display window 150 during a normal game, seven free games are awarded as a free game trigger. When five or more “FEATURE” symbols are appeared in the display window 150 during a free game, five additional free games are awarded in this embodiment as a re-trigger (re-execution right of free games). Two “FEATURE” symbols are arranged in each reel 101 to 105, and ten “FEATURE” symbols are arranged in total.

### (Roulette Type Selection Table and Roulette Type Selection Number Association Table)

With reference to FIG. 12 and FIG. 13, the roulette type selection table and the roulette type selection number association table are described next.

When five or more “FEATURE” symbols are rearranged in the display window 150 during a normal game, the slot machine 1 in this embodiment shifts the game from the normal game to seven free games as the free game trigger (an award of execution right of free games). In this free game, when one or more “FEATURE” symbols are appeared on any places in the display window 150, the payouts are awarded in accordance with the number of “FEATURE” symbols appeared in the display window 150. Then, the entertaining effects are represented in which the payout for one “FEATURE” symbol is determined as the reference payout value (‘FEATURE symbol payout determination process’ described below).

The roulette type selection table shown in FIG. 12 is referred during the roulette type selection process (described below) in the course of the ‘FEATURE symbol payout determination process’ in which the payout for one “FEATURE” symbol is determined as the reference payout value as described above. Furthermore, the roulette type selection number association table shown in FIG. 13 is referred during a determination process for the number of roulette type selections in which the number of execution of roulette type selection processes is determined (described below).

The roulette type selection number association table shown in FIG. 13 includes the number of selections in order to execute the roulette type selection process associated with the number of the “FEATURE” symbols appeared in the display window 150 during the normal game or the free game. For example, when seven “FEATURE” symbols are rearranged in the display window 150 during the normal game, the roulette type selection number association table shown in FIG. 13 is referred, and the roulette type selection process is executed three times.

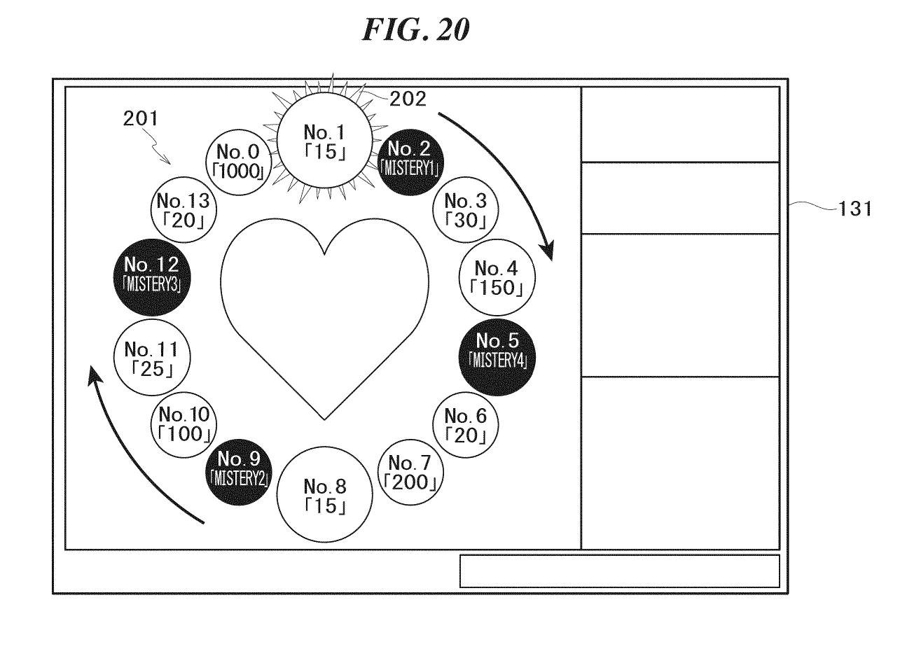

In the roulette type selection table shown in FIG. 12, region numbers (No. 0 to 13) arranged in a roulette 201 (see FIG. 20), the fixed payout regions associated with predetermined payout values (“No. 0: 1000”, “No. 1: 15”, “No. 3: 30”, “No. 4: 150”, “No. 6: 20”, “No. 7: 200”, “No. 8: 15”, “No. 10: 100”, “No. 11: 25”, “No. 13: 20”), the non-fixed payout regions (mystery award regions: “No. 2: MYSTERY”, “No. 5: MYSTERY”, “No. 9: MYSTERY”, “No. 12: MYSTERY”), and weights (winning rates) are associated with each other. When the roulette type selection table shown in FIG. 12 is referred during the roulette type selection process, a drawing is performed in accordance with the weight. In the case where the region number “No. 0” is selected with the probability of 1/100, the payout value of “1000” is awarded.

### (Non-Fixed Payout Region Transfer Table)

Next, the non-fixed payout region transfer table is described with reference to FIG. 14.

The roulette type selection table described above (see FIG. 12) includes four non-fixed payout regions (“No. 2: MYSTERY”, “No. 5: MYSTERY”, “No. 9: MYSTERY”, and “No. 12: MYSTERY”). In this embodiment, four non-fixed payout regions are associated with any of four payout drawing tables (MYSTERY1 to 4) that include different payout values and winning rates described below in the MYSTERY position determination process described below. The non-fixed payout region transfer table is referred during the MYSTERY position determination process.

In the non-fixed payout region transfer table, as shown in FIG. 14, twenty-four table codes (TABLE A to X), four region numbers corresponding to the non-fixed payout regions (No. 2, No. 5, No. 9, No. 12), four payout drawing tables (MYSTERY1 to 4), and weights (winning rates: 1/24 for each) are associated with each other. For example, when the non-fixed payout region transfer table is referred during the MYSTERY position determination process and a table code (TABLE E) is selected by the winning rate of 1/24, the region number (No. 2) is associated with the payout drawing table for MYSTERY1, the region number (No. 5) is associated with the payout drawing table for MYSTERY4, the region number (No. 9) is associated with the payout drawing table for MYSTERY2, and the region number (No. 12) is associated with the payout drawing table for MYSTERY3.

(Payout Drawing Table for MYSTERY1 to 4)

Next, the payout drawing tables for MYSTERY1 to 4 are described with reference to FIG. 15A to 15D. For example, as a result of the MYSTERY position determination process as described above, when the region number (No. 2) is associated with the payout drawing table for MYSTERY1, the region number (No. 5) is associated with the payout drawing table for MYSTERY4, the region number (No. 9) is associated with the payout drawing table for MYSTERY2, and the region number (No. 12) is associated with the payout drawing table for MYSTERY3, four non-fixed payout regions (No. 2, No. 5, No. 9, No. 12) in the roulette type selection table are respectively associated with the payout drawing tables (“No. 2: MYSTERY1”, “No. 5: MYSTERY4”, “No. 9: MYSTERY2”, “No. 12: MYSTERY3”).

In the payout drawing table for MYSTERY1, five numbers (No. 0 to No. 4), payouts (300, 250, 200, 150, 100), and weights (winning rates: 1/30, 1/30, 1/30, 12/30, 15/30) are associated with each other. In the payout drawing table for MYSTERY2, five numbers (No. 0 to No. 4), payouts (150, 100, 75, 50, 30), and weights (winning rates: 1/30, 1/30, 1/30, 12/30, 15/30) are associated with each other. In the payout drawing table for MYSTERY3, five numbers (No. 0 to No. 4), payouts (50, 30, 25, 20, 15), and weights (winning rates: 6/30, 7/30, 11/30, 5/30, 1/30) are associated with each other. In the payout drawing table for MYSTERY4, five numbers (No. 0 to No. 4), payouts (100, 75, 50, 40, 30), and weights (winning rates: 2/30, 2/30, 13/30, 11/30, 2/30) are associated with each other. As described above, four payout drawing tables (MYSTERY1 to 4) are specified so that the payout values and the weights (winning rates) are different in the respective tables.

(Description of Display During Roulette Type Selection)

With reference to FIG. 20, the image display appeared on the upper image display panel 131 during the roulette type selection process executed in the ‘FEATURE symbol payout determination process’ described below will be described.

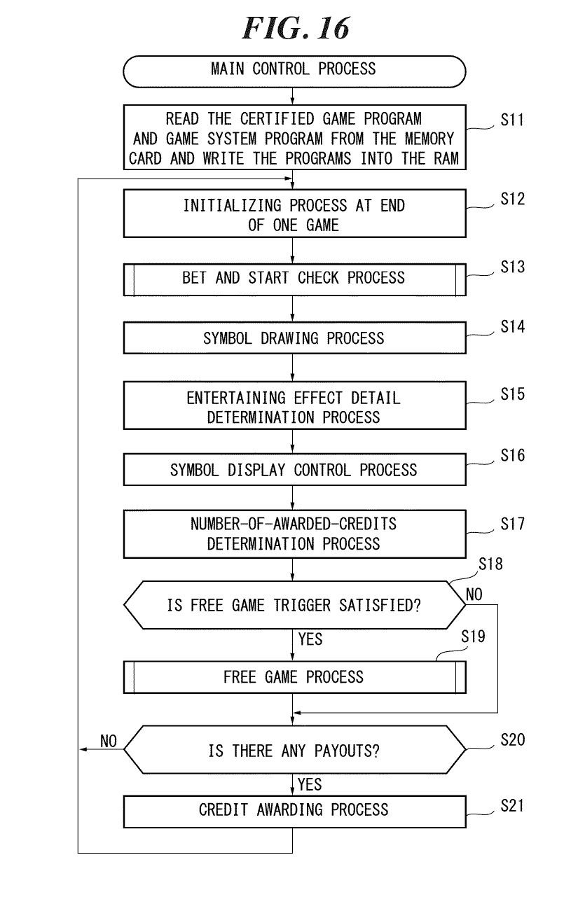

As shown in FIG. 20, the roulette 201 is displayed on the upper image display panel 131 during the roulette type selection process. In the roulette 201, the fixed payout regions associated with the predetermined payout values (“No. 0: 1000”, “No. 1: 15”, “No. 3: 30”, “No. 4: 150”, “No. 6: 20”, “No. 7: 200”, “No. 8: 15”, “No. 10: 100”, “No. 11: 25”, “No. 13: 20”) and the non-fixed payout regions (“No. 2: MYSTERY1”, “No. 5: MYSTERY4”, “No. 9: MYSTERY2”, “No. 12: MYSTERY3”) are arranged around a heart-shaped mark 202. The mark 202 is lit and displayed (increases a luminous intensity) on each of the fixed payout regions and the non-fixed payout regions of the roulette 201 for indicating the winning in the clockwise order from No. 0 to No. 13. Thus, the mark 202 is lit and displayed on each of the fixed payout regions and the non-fixed payout regions of the roulette 201 in the clockwise order from No. 0 to No. 13, and the rotation of the roulette is displayed with entertaining effects. The fixed payout region refers to a winning region associated with the predetermined payout value in the roulette. The non-fixed payout region refers to the region other than the fixed payout region and the winning region where the payout value associated with the non-fixed payout region is not determined in advance and the payout value associated with the non-fixed payout region is determined in a drawing in this embodiment.

[Contents of Program] Next, with reference to FIG. 16 to FIG. 19, programs executed by the slot machine 1 will be described.

(Main Control Process)

A main control process is described first with reference to FIG. 16. In the beginning, when power is supplied to the slot machine 1, the main CPU 71 reads the certified game program and game system program from the memory card 54 through the gaming board 50 and writes the programs into the RAM 73 (Step S11).

Next, in order to start the normal game, the main CPU 71 carries out an initializing process at the end of one game (Step S12). For example, unnecessary data such as the number of bets and symbols determined in a drawing is cleared from the work area in the RAM 73 at every normal game.

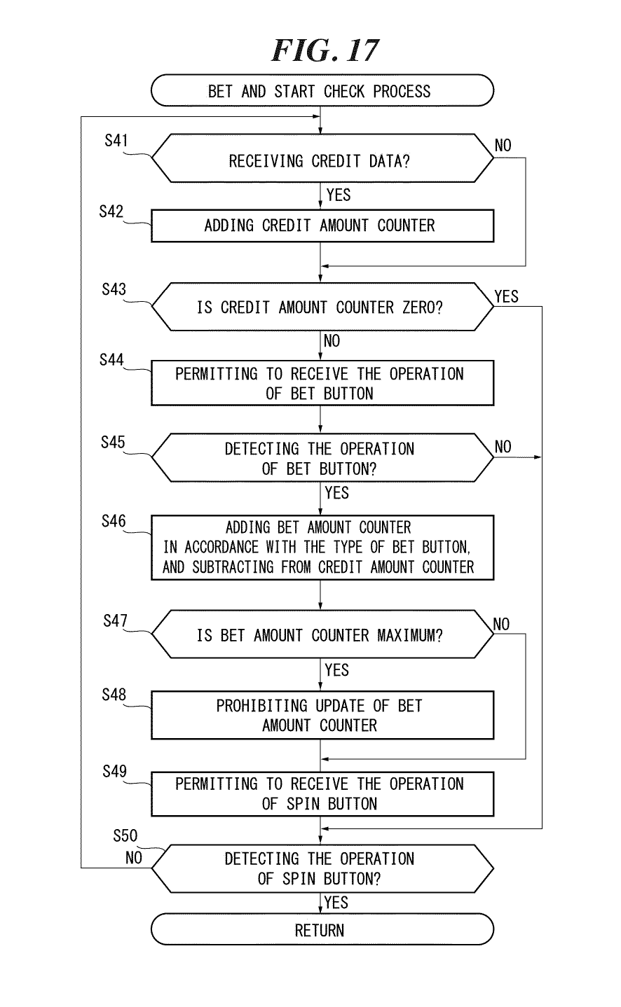

Next, the main CPU 71 carries out a bet and start check process described below with reference to FIG. 17 (Step S13). In this process, the main CPU 71 makes a check of inputs of the 30-BET switch 34S, the 60-BET switch 35S, the 90-BET switch 36S, the 120-BET switch 37S, the 150-BET switch 38, the spin switch 46S, and the like.

Next, the main CPU 71 carries out a symbol drawing process (S14). In this process, symbols to be stopped are determined in accordance with a random value for symbol determination.

Specifically, the main CPU 71 extracts the random value for symbol determination first. Next, the main CPU 71 determines the symbols to be stopped for each of the reels 101 to 105 in a drawing. The main CPU 71 draws one of twenty-two symbols with respect to each of the reels 101 to 105 to determine as the symbol to be stopped. At that time, the symbols to be stopped are determined with the probability in accordance with the weight shown in FIG. 6. The main CPU 71 then stores the determined symbols to be stopped for each of the reels 101 to 105 in a symbol storage area provided in the RAM 73.

Next, the main CPU 71 carries out an entertaining effect detail determination process (Step S15). The main CPU 71 extracts a random value for entertaining effects and determines any of predetermined entertaining effect details in a drawing.

Next, the main CPU 71 carries out a symbol display control process (Step S16). In this process, symbol arrays of the reels 101 to 105 start to scroll, and the symbols to be stopped that are determined in the symbol drawing process of the step S14 stop at the predetermined positions (in the middle row region of the display window 150). In other words, fifteen symbols including the symbols to be stopped are rearranged in the display window 150. For example, in a case where the symbol to be stopped in the first reel 101 is the symbol of the code number “10” and that symbol is displayed in the middle row region, symbols of code numbers “9”, “10”, and “11” (“BLANK”, “BLUE7”, and “BLANK”) are respectively rearranged in the upper row, the middle row, and the lower row of the display window 150.

Next, the main CPU 71 carries out a number-of-awarded-credits determination process (Step S17). In this process, the symbol combination table (see FIG. 11) stored in the RAM 73 is referred, and the payouts are determined in accordance with the combination of the symbols appeared on the effective pay lines 1 to 30 and stored in the number-of-awarded-credits storage area provided in the RAM 73.

Next, the main CPU 71 determines whether the free game trigger (execution right of free game) is satisfied or not (Step S18). The free game trigger in transferring to free games in this embodiment is five or more “FEATURE” symbols appeared on any places in the display window 150. When the main CPU 71 determines that the free game trigger is satisfied (S18: YES), the main CPU 71 carries out a free game process described below (Step S19).

Next, after the process of the step S19 or in step S18, when the main CPU 71 determines that the free game trigger is not satisfied (S18: NO), the main CPU 71 determines whether there is a payout or not (S20). This determines whether the payout is awarded or not in the process of the step S17 or the step S19. When it is determined that there is a payout (S20: YES), the main CPU 71 carries out a credit awarding process (Step S21). The main CPU 71 adds the value stored in the number-of-awarded-credits storage area and the total-credits storage area for free game to the value stored in the number-of-credits storage area provided in the RAM 73. In accordance with the input of the CASH-OUT switch 32S, the main CPU 71 may control the PTS device 700 to write as credit data representing the value stored in the number-of-credits storage area to the IC card inserted into the card insertion slot. After this process is carried out, or when it is determined that there is no payout in the process of the step S20 (S20: NO), the process returns to the step S12.

(Bet and Start Check Process)

Next, a bet and start check process is described with reference to FIG. 17.

First, the main CPU 71 determines whether the credit data has been received from the PTS device 700 or not (Step S41). The credit data is sent from the PTS device 700 to the main CPU 71 when the IC card is inserted into the card insertion slot and when the bill entry 60 receives a regular bill.

When the main CPU 71 determines that the credit data is received (S41: YES), the main CPU 71 adds the amount indicated by the received credit data to the value stored in the number-of-credits storage area (Step S42).

When the main CPU 71 determines that the credit data is not received after the step S42 or in the step S41 (S41: NO), the main CPU 71 determines whether the value stored in the number-of-credits storage area is zero or not (Step S43). When the main CPU 71 determines that the value stored in the number-of-credits storage area is not zero (S43: NO), the main CPU 71 permits to receive the operation of BET buttons (30-BET button 34, 60-BET button 35, 90-BET button 36, 120-BET button 37, 150-BET button 38) (Step S44).

Next, the main CPU 71 determines whether the operation of BET buttons is detected or not (Step S45). When the main CPU 71 detects with the BET switches (30-BET switch 34S, 60-BET switch 35S, 90-BET switch 36S, 120-BET switch 37S, 150-BET switch 38S) that the player pushes any of the BET buttons, the main CPU 71 adds the value based on the type of the BET button to the value stored in a number-of-BET storage area provided in the RAM 73 and subtracts it from the value stored in the number-of-credits storage area (Step S46).

Next, the main CPU 71 determines whether the value stored in the number-of-BET storage area is the maximum or not (Step S47). When the main CPU 71 determines that the value stored in the number-of-BET storage area is the maximum (S47: YES), the main CPU 71 disables an update of the value stored in the number-of-BET storage area (Step S48). When the main CPU 71 determines that the value stored in the number-of-BET storage area is not the maximum after the step S48 or in the step S47 (S47: NO), the main CPU 71 permits to receive the operation of the spin button 46 (Step S49).

When the main CPU 71 determines that the operation of the BET button is not detected after the step S49 and in the step S45 (S45: NO) or that the value stored in the number-of-credits storage area is zero in the step S43 (S43: YES), the main CPU 71 determines whether the operation of the spin button 46 is detected or not (Step S50). When the main CPU 71 determines that the operation of the spin button 46 is not detected (S50: NO), the main CPU 71 proceeds the process to the step S41.

In contrast, when the main CPU 71 determines that the operation of the spin button 46 is detected (S50: YES), the main CPU 71 terminates the bet and start check process.

(Free Game Process)

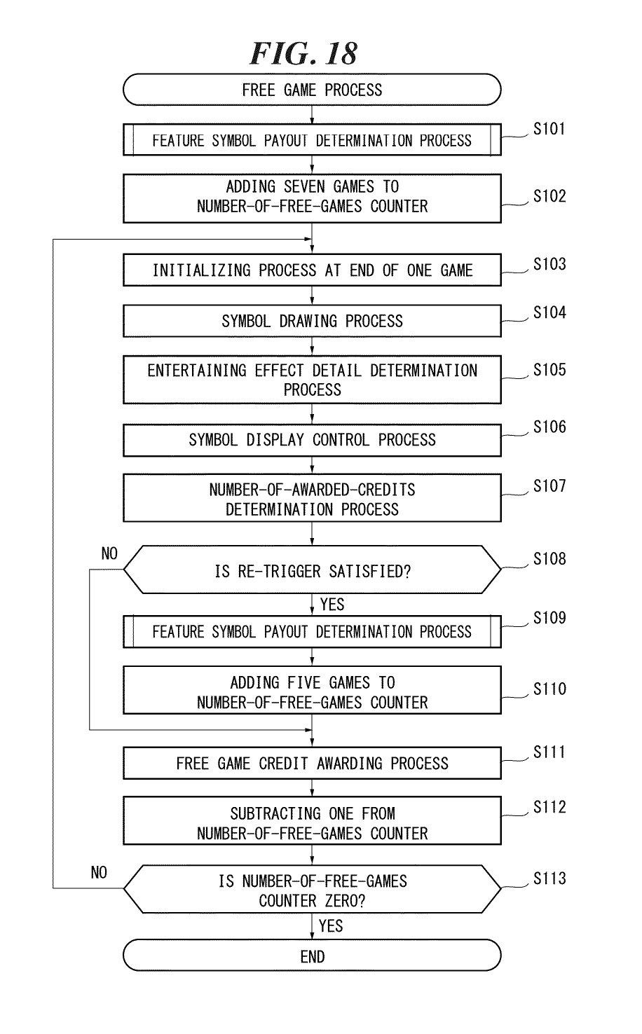

Next, a free game process is described with reference to FIG. 18. FIG. 18 shows a flowchart of the free game process in the slot machine according to the embodiment of the present invention.

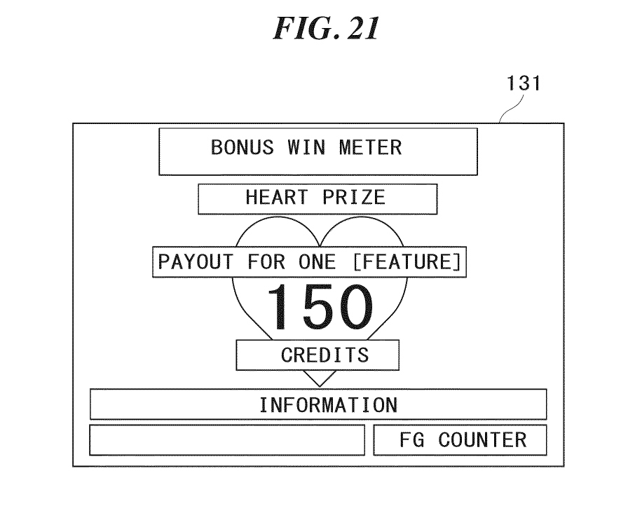

First, the main CPU 71 executes the FEATURE symbol payout determination process described below (S101). In the free game, when one or more “FEATURE” symbols are appeared on any places in the display window 150, the payouts are awarded in accordance with the number of “FEATURE” symbols appeared in the display window 150. In this FEATURE symbol payout determination process, although the details are described later, the reference payout value that is the payout for one “FEATURE” symbol appeared in the display window 150 is determined. As shown in FIG. 21, the determined reference payout value is displayed on the upper image display panel 131 as an item of payout for one [FEATURE].

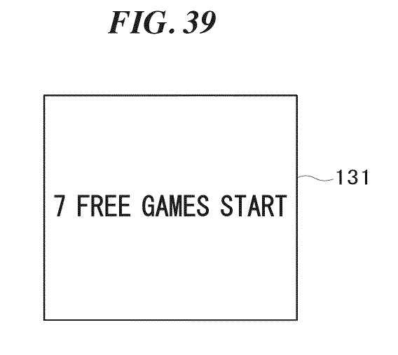

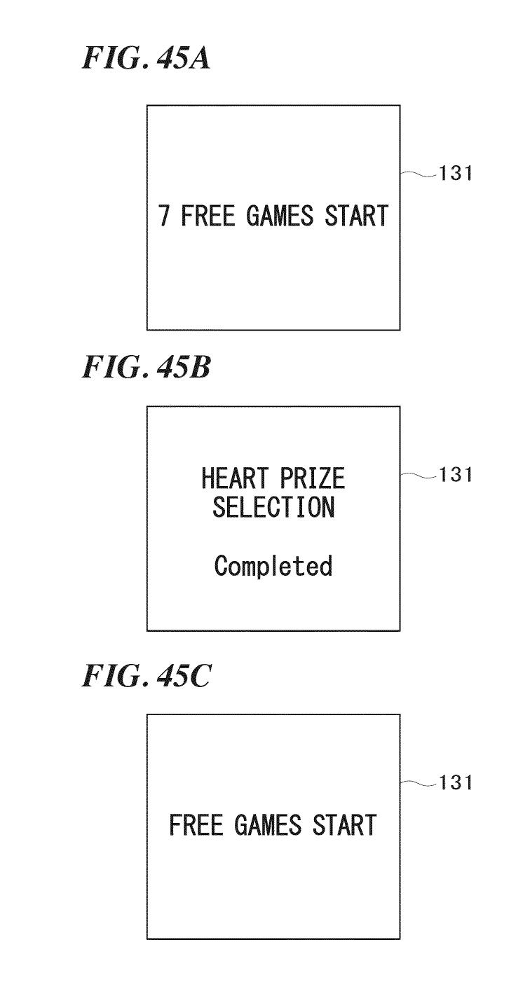

Next, the main CPU 71 adds seven free games to a number-of-free-games counter of the RAM 73 and stores it (S102). At this time, as shown in FIG. 39, a message of “7 FREE GAMES START” is displayed on the upper image display panel 131 (see FIG. 45A).

Next, the main CPU 71 carries out, as the process in the step S12, the initializing process at the end of one game (Step S103). For example, unnecessary data such as the symbols determined in a drawing during the free game is cleared from the work area in the RAM 73 at every free game.

Next, the main CPU 71 carries out the symbol drawing process similar to that in S14 (Step S104). Specifically, the main CPU 71 extracts the random value for symbol determination first. Next, the main CPU 71 determines the symbols to be stopped for the reels 101 to 105 in a drawing. The main CPU 71 draws one of twenty-two symbols with respect to each of the reels 101 to 105 to determine as the symbol to be stopped. At that time, the symbols to be stopped are determined with the probability in accordance with the weight shown in FIG. 7. The main CPU 71 then stores the determined symbols to be stopped for the reels 101 to 105 in a symbol storage area provided in the RAM 73.

Next, the main CPU 71 carries out, as the process in the step S15, the entertaining effect detail determination process (Step S105). Next, the main CPU 71 carries out, as the process in the step S16, the symbol display control process (Step S106).

Next, the main CPU 71 carries out, as the process in the step S17, the number-of-awarded-credits determination process (Step S107). In this process, the symbol combination table (see FIG. 11) stored in the RAM 73 is referred, and the payouts are determined in accordance with the combination of the symbols appeared on the effective pay lines 1 to 30 and stored in the number-of-awarded-credits storage area for free game provided in the RAM 73.

Furthermore, in S107, the number of the “FEATURE” symbols appeared in the display window 150 as a result of the symbol display control process in S106 is determined. In the process of S215 for the FEATURE symbol payout determination process, the value obtained by multiplying the determined number of the “FEATURE” symbols by the reference payout value (payout for one “FEATURE” symbol appeared in the display window 150) stored in the reference payout value storage area of the RAM 73 (reference payout value×the number of “FEATURE” symbols) is stored in the number-of-awarded-credits storage area for free game provided in the RAM 73.

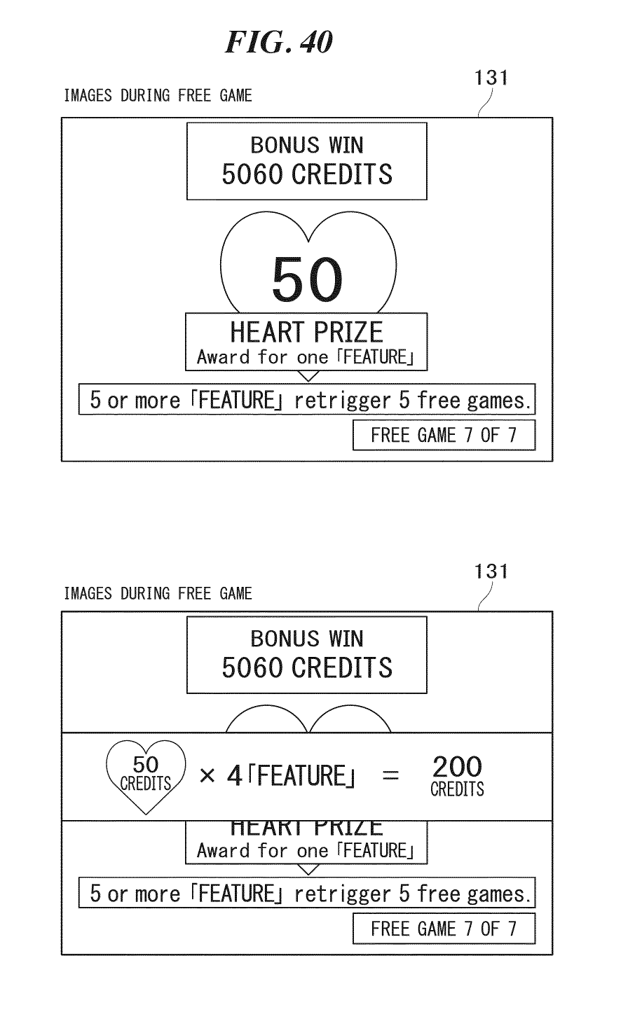

At this time, as shown in FIG. 40, the upper image display panel 131 displays the reference payout value and then displays ‘Reference Payout Value×Number of “FEATURE” symbols=Payouts’. For example, as shown in FIG. 40, when the reference payout value is “50” and the number of the “FEATURE” symbols are four, the upper image display panel 131 displays “50×4=200 Credits”.

Next, the main CPU 71 determines whether the re-trigger is satisfied or not (Step S108). The re-trigger in this embodiment is five or more “FEATURE” symbols appeared on any places in the display window 150. When the main CPU 71 determines that the re-trigger is satisfied (S108: YES), the main CPU 71 executes the FEATURE symbol payout determination process again (Step S109). The payout value awarded through the FEATURE symbol payout determination process after the re-trigger is awarded and added to the reference payout value awarded through the FEATURE symbol payout determination process in a first free game trigger, and the reference payout value is updated. Thus, once the re-trigger is satisfied, the reference payout value that is the payout for one “FEATURE” symbol appeared in the display window 150 increases, and the player gains an advantage.

Next, the main CPU 71 adds five free games to the number-of-free-games counter of the RAM 73 and stores it (S110).

Next, when the main CPU 71 determines that the re-trigger is not satisfied (S108: NO), or after the process of S110, the main CPU 71 carries out a free game credit awarding process (Step S111). In the free game credit awarding process, the main CPU 71 adds the value stored in the number-of-awarded-credits storage area for free game during the number-of-awarded-credits determination process of the step S107 described above to the value stored in the total-credits storage area for free game. The total-credits storage area for free game is an area for storing the total of payouts determined during the free games. When the free game process is finished, the main CPU 71 adds, in the credit awarding process of the step S21, the value stored in the total-credits storage area for free game to the value stored in the number-of-credits storage area provided in the RAM 73. In other words, the total payout determined during the free games are awarded in a lump sum.

Next, the main CPU 71 subtracts one from the value stored in the number-of-free-games counter (S112). Next, the main CPU 71 determines whether the value stored in the number-of-free-games counter is zero or not (S113). When the main CPU 71 determines that the value stored in the number-of-free-games counter is not zero (S113: NO), the process moves to S103.

In contrast, when the main CPU 71 determines that the value stored in the number-of-free-games counter is zero (S113: YES), the main CPU 71 terminates the free game process. When the free game process is finished, the process moves to the process of the step S20 described with reference to FIG. 16.

(FEATURE Symbol Payout Determination Process)

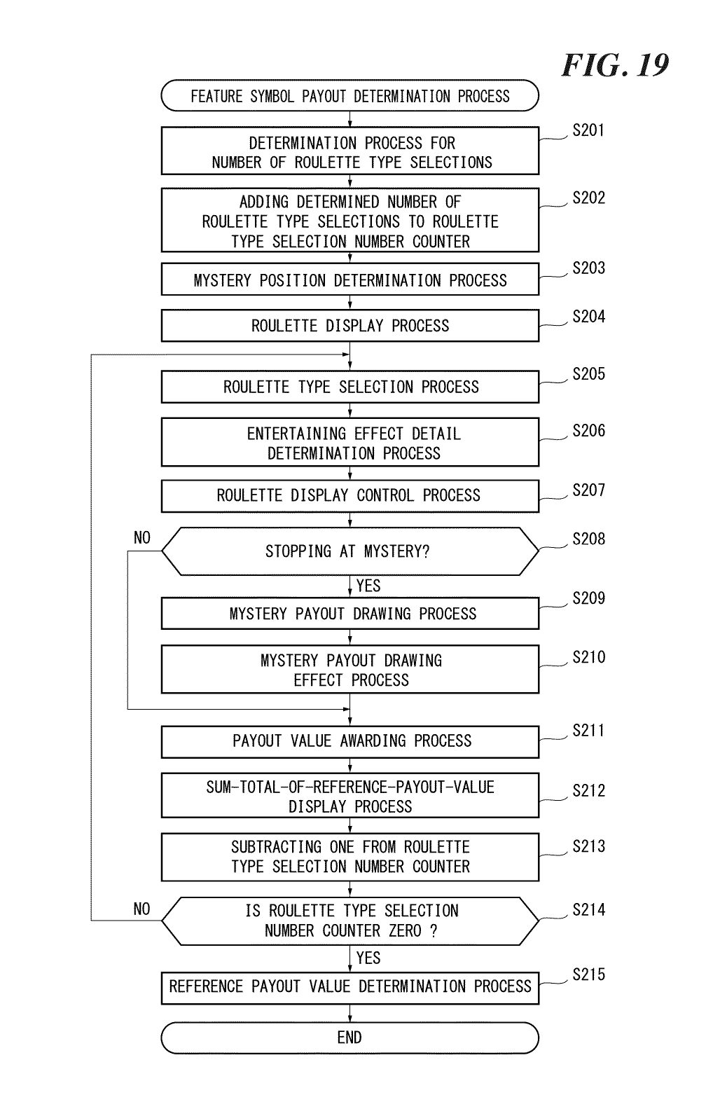

Next, a FEATURE symbol payout determination process is described with reference to FIG. 19. FIG. 19 shows a flowchart of the FEATURE symbol payout determination process in the slot machine according to the embodiment of the present invention.

First, the main CPU 71 executes the determination process for the number of roulette type selections (S201). In this determination process for the number of roulette type selections, the main CPU 71 determines, as a result of the symbol display control process in S16 or S106, how many “FEATURE” symbols are rearranged in the display window 150.

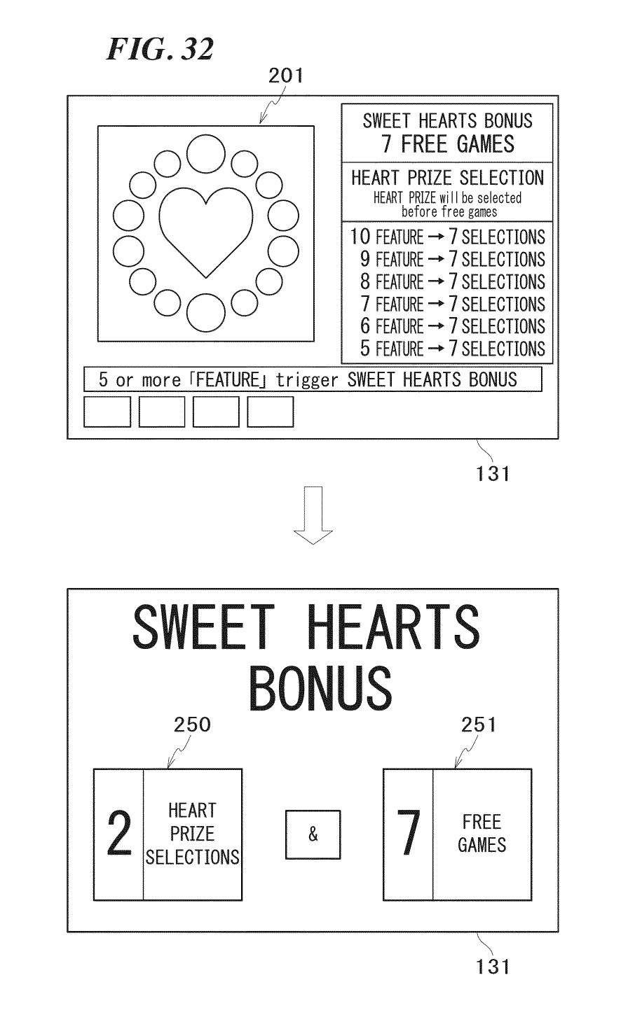

Next, the main CPU 71 refers to the roulette type selection number association table (FIG. 13), determines the number of roulette type selections associated with the number of the “FEATURE” symbols determined in the process of S201, and adds the determined number of roulette type selections to the roulette type selection number counter in the RAM 73 (S202). For example, when six “FEATURE” symbols are rearranged in the display window 150, the roulette type selection number association table is referred, and the roulette type selection number of two is added to the roulette type selection number counter. At this time, as shown in FIG. 32, the value of the roulette type selection number counter is displayed in the display item of “HEART PRIZE SELECTION” 250, and the awarded number of free games is displayed in the display item of “FREE GAMES” 251.

Next, the main CPU 71 executes the MYSTERY position determination process (corresponding to a non-fixed payout region transfer drawing) (S203). This MYSTERY position determination process is a process for associating four non-fixed payout regions (“No. 2: MYSTERY”, “No. 5: MYSTERY”, “No. 9: MYSTERY”, “No. 12: MYSTERY”) in the roulette type selection table shown in FIG. 12 with any of four payout drawing tables (MYSTERY1 to 4).

Specifically, the main CPU 71 refers to the non-fixed payout region transfer table (FIG. 14) described above to select one table code from twenty-four table codes (TABLE A to X) in a drawing. At this time, the table code is selected with the winning rate (1/24) in accordance with the weights shown in FIG. 14. Then, the main CPU 71 associates, in accordance with the selected table code, four non-fixed payout regions (“No. 2: MYSTERY”, “No. 5: MYSTERY”, “No. 9: MYSTERY”, “No. 12: MYSTERY”) in the roulette type selection table with four payout drawing tables (MYSTERY1 to 4). For example, when the non-fixed payout region transfer table is referred during the MYSTERY position determination process and a table code (TABLE E) is selected by the winning rate of 1/24, on the roulette type selection table, the region number (No. 2) is associated with the payout drawing table for MYSTERY1, the region number (No. 5) is associated with the payout drawing table for MYSTERY4, the region number (No. 9) is associated with the payout drawing table for MYSTERY2, and the region number (No. 12) is associated with the payout drawing table for MYSTERY3.

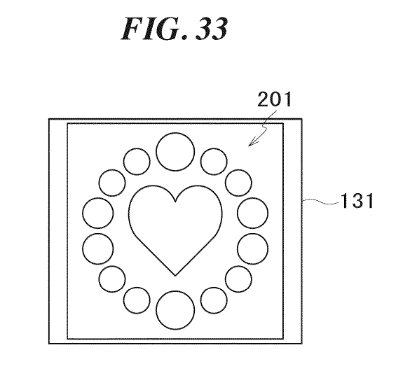

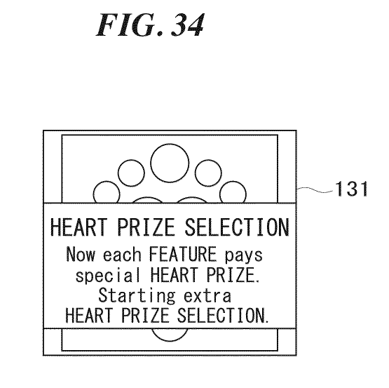

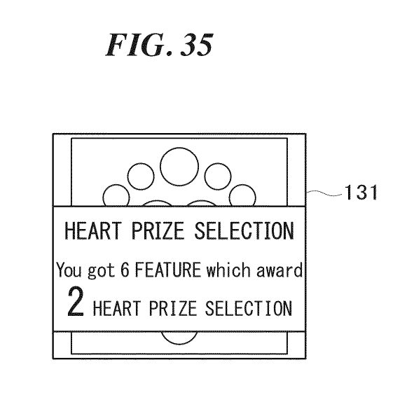

Next, the main CPU 71 executes a roulette display process (S204). In this roulette display process, the roulette 201 shown in FIG. 20 is displayed on the upper image display panel 131. First, as shown in FIG. 33, the roulette 201 is displayed on the upper image display panel 131. Next, as shown in FIG. 34, the description of the roulette is displayed on the upper image display panel 131. Next, as shown in FIG. 35, the description about the number of roulette type selections determined in the process of S202 is displayed. Then, as shown in FIG. 20, the upper image display panel 131 displays associated four payout drawing tables (MYSTERY1 to 4) determined in the process of S203 with four non-fixed payout regions (“No. 2: MYSTERY”, “No. 5: MYSTERY”, “No. 9: MYSTERY”, “No. 12: MYSTERY”).

Next, the main CPU 71 executes a roulette type selection process (S205). Specifically, the main CPU 71 refers to the roulette type selection table (FIG. 12) described above to select one region number from fourteen region numbers (No. 0 to 13) in a drawing. At this time, the region number is selected with the winning rate in accordance with the weights shown in FIG. 12.

Next, the main CPU 71 carries out the entertaining effect detail determination process (Step S206). The main CPU 71 extracts a random value for entertaining effects and determines any of predetermined entertaining effect details in a drawing.

Next, the main CPU 71 executes a roulette display control process (S207). In this roulette display control process, the mark 202 is lit and displayed on each of the fixed payout regions and the non-fixed payout regions of the roulette 201 shown in FIG. 20 in the clockwise order from No. 0 to No. 13, and the rotation of the roulette is displayed with entertaining effects. Then, the mark 202 stops at the region number selected in S205.

Next, the main CPU 71 determines through the process of S207 whether the region where the mark 202 stops is the non-fixed payout region (“No. 2: MYSTERY1”, “No. 5: MYSTERY4”, “No. 9: MYSTERY2”, “No. 12: MYSTERY3”) or not (S208).

When the main CPU 71 determines that the region where the mark 202 stops is the non-fixed payout region (S208: YES), the main CPU 71 executes a mystery payout drawing process (S209). In this mystery payout drawing process, the payout drawing table (see FIG. 15A to 15D) associated with the stopped non-fixed payout region (“No. 2: MYSTERY1”, “No. 5: MYSTERY4”, “No. 9: MYSTERY2”, “No. 12: MYSTERY3”) is used, and the drawing is carried out. For example, if the region where the mark 202 stops is “No. 2: MYSTERY1”, then the main CPU 71 refers to the payout drawing table for MYSTERY1 shown in FIG. 15A and selects one number from five numbers (No. 0 to No. 4) in a drawing. At this time, the number is selected with the winning rate in accordance with the weights shown in the payout drawing table for MYSTERY1 of FIG. 15A.

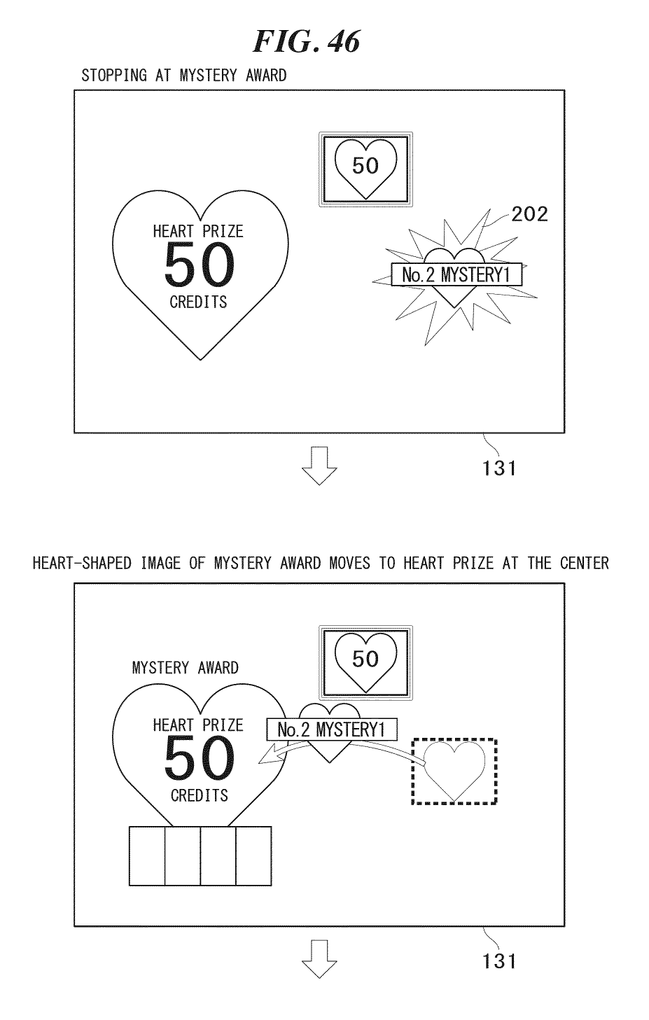

When it is determined that the region where the mark 202 stops is the non-fixed payout region (S208: YES), as shown in FIG. 46, the upper image display panel 131 displays the entertaining effects in which the non-fixed payout region (No. 2: MYSTERY1 in FIG. 46) is enlarged and moves to a heart-shaped mystery award sign 241 at the center.

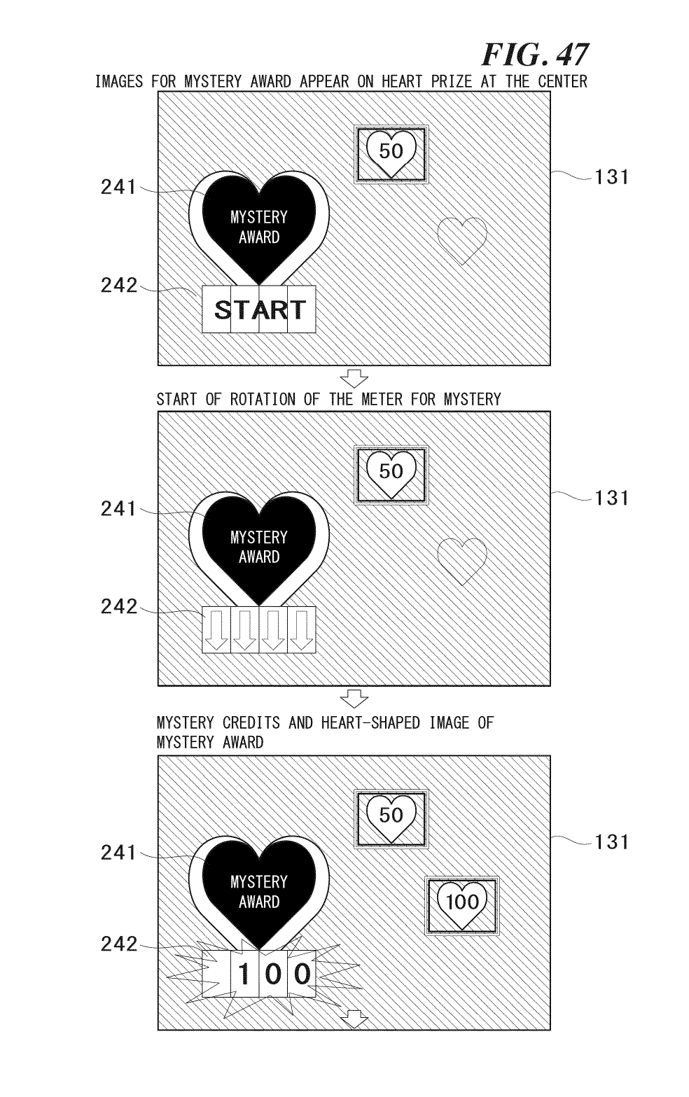

Next, the main CPU 71 executes a mystery payout drawing effect process (S210). In this mystery payout drawing effect process, the main CPU 71 displays, as shown in FIG. 47, a word ‘Start’ on a meter 242. Next, the payout values associated with the applicable payout drawing table in FIG. 15A to 15D are displayed by scrolling in order, and then, as shown in FIG. 47, the payout value corresponding to the determined number in the mystery payout drawing process of S209 is displayed to stop on the meter 242. For example, when the region where the mark 202 stops is “No. 2: MYSTERY1”, the payout values of “300”, “250”, “200”, “150”, and “100” associated with the payout drawing table for MYSTERY1 in FIG. 15A are displayed on the meter 242 by scrolling. Then, if the determined number in the mystery payout drawing process of S209 is “4”, with reference to the payout drawing table for MYSTERY1, the payout value of “100” corresponding to the number “4” is displayed to stop on the meter 242 (see FIG. 47).

Next, after the process of S210, or when the main CPU 71 determines that the region where the mark 202 stops is not the non-fixed payout region (S208: NO), the main CPU 71 executes a payout value awarding process (S211). In this payout value awarding process, when the process moves from S210 to S211, the payout drawing tables shown in FIG. 15A to 15D are referred, and in the process of S210, the payout value displayed to stop on the meter 242 is added to and stored in the reference payout value storage area provided in the RAM 73. In contrast, when it is determined that the region where the mark 202 stops is not the non-fixed payout region (S208: NO), the region where the mark stops is determined as the fixed payout region, and thus the payout value associated with the stopped fixed payout region is added to and stored in the reference payout value storage area provided in the RAM 73.

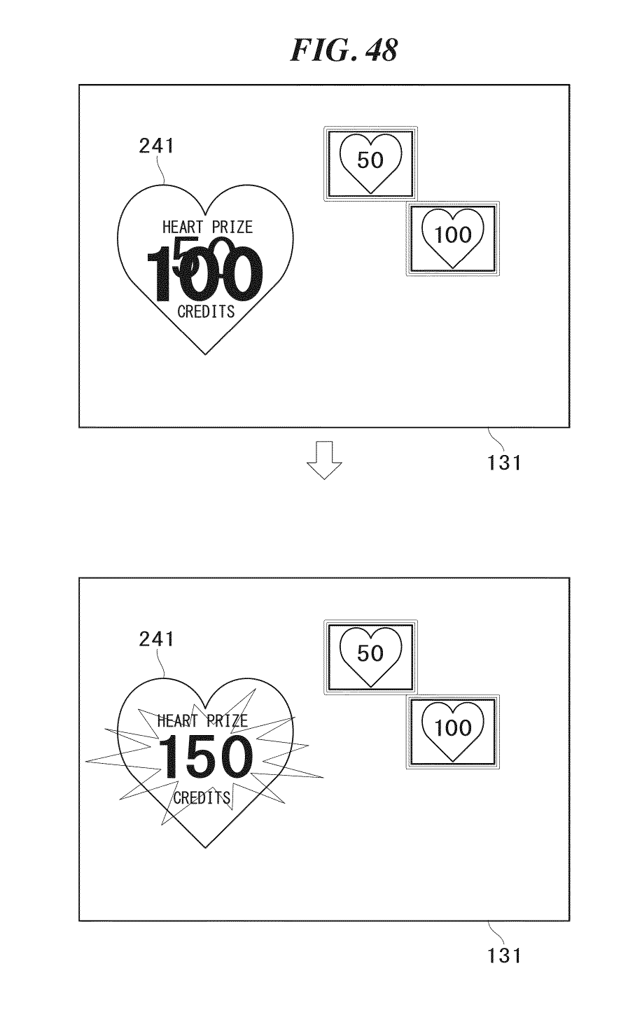

Next, the main CPU 71 executes a sum-total-of-reference-payout-value display process. In this sum-total-of-reference-payout-value display process, as shown in FIG. 48, the meter 242 disappears from the upper image display panel 131, the payout value displayed and stopped on the meter 242 in the process of S210 is added to the value stored in the reference payout value storage area, and the entertaining effect in which the total value is displayed on the mystery award sign 241 is carried out. In the case of the fixed payout region, the payout value associated with the fixed payout region is added to the value stored in the reference payout value storage area, and the entertaining effect in which the total value is displayed on the mystery award sign 241 is carried out.

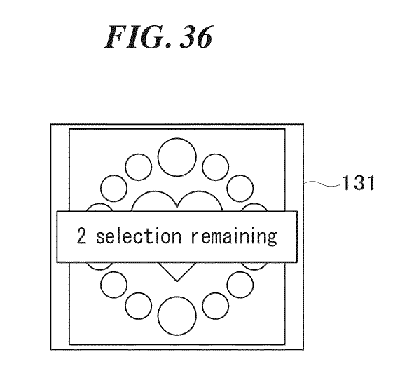

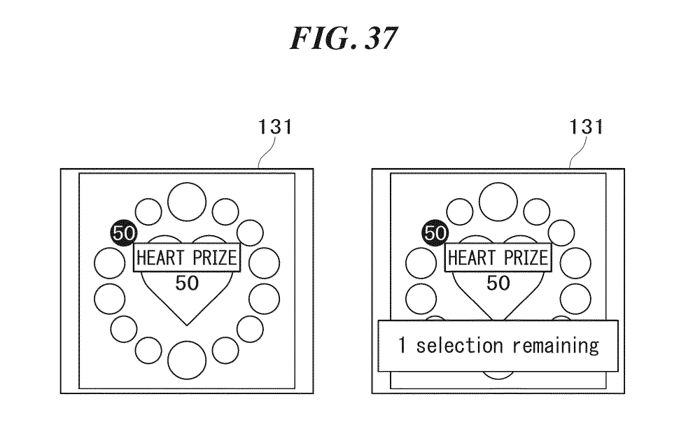

Next, the main CPU 71 subtracts one from the value stored in the roulette type selection number counter (S213). Next, the main CPU 71 determines whether the value stored in the roulette type selection number counter is zero or not (S214). When the main CPU 71 determines that the value stored in the roulette type selection number counter is not zero (S214: NO), the process moves to S205. At this time, the main CPU 71 displays, as shown in FIG. 36 and FIG. 37, the value stored in the roulette type selection number counter on the upper image display panel 131 and provides information about the remaining number of roulette type selections to the player.

On the other hand, when it is determined that the value stored in the roulette type selection number counter is zero (S214: YES), the main CPU 71 executes a reference payout value determination process (S215). In this reference payout value determination process, the value stored in the reference payout value storage area of the RAM 73 is determined, in the free game process, as the reference payout value that is the payout for one “FEATURE” symbol appeared in the display window 150.

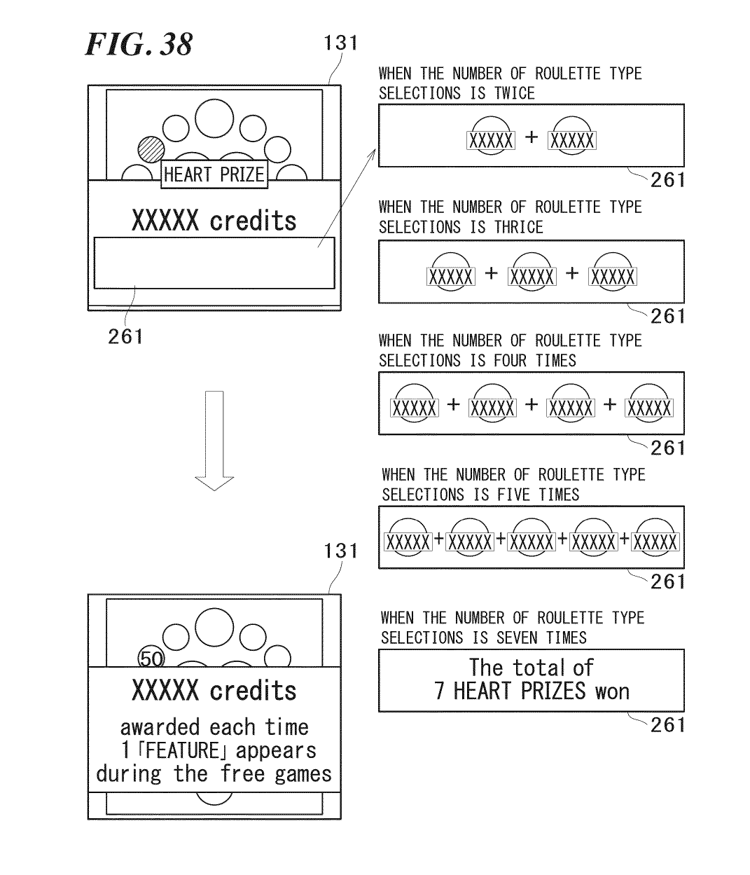

At this time, the details of the value stored in the reference payout value storage area are displayed (FIG. 38). Specifically, as shown in FIG. 38, the payout values awarded as a result of the number of times in accordance with the number of roulette type selections awarded in the processes of S201 and S202 are separately displayed. For example, when the number of roulette type selections awarded in the processes of S201 and S202 is twice, a display item 261 displays the payout value awarded as a result of the roulette type selection on a first try and the payout value awarded as a result of the roulette type selection on a second try. When the number of roulette type selections awarded in the processes of S201 and S202 is seven times, the display item 261 displays a message of ‘The total of 7 HEART PRIZES won’ (see FIG. 38).

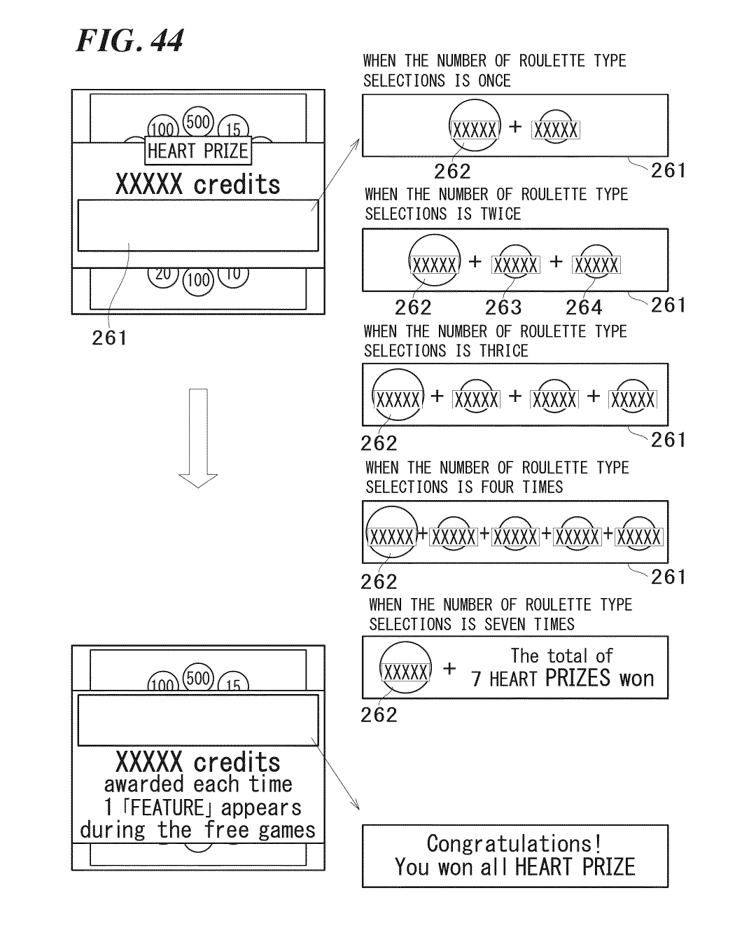

When the re-trigger is satisfied in the process of S108, as shown in FIG. 44, a total of payout values 262 awarded in the first free game trigger is collectively displayed in the display item 261, and the payout values awarded as a result of the number of times in accordance with the number of roulette type selections awarded in the processes of S201 and S202 after the re-trigger is satisfied are separately displayed. For example, when the number of roulette type selections awarded in the processes of S201 and S202 is twice, the display item 261 displays the total of payout values 262 awarded in the first free game trigger, a payout value 263 awarded as a result of the roulette type selection on the first try, and a payout value 264 awarded as a result of the roulette type selection on the second try (see FIG. 44). When the number of roulette type selections awarded in the processes of S201 and S202 is seven times, the display item 261 displays the total of payout values 262 awarded in the first free game trigger and the message of ‘The total of 7 HEART PRIZES won’ (see FIG. 44).

Then, this FEATURE symbol payout determination process is finished. When the FEATURE symbol payout determination process is finished, the process moves to the process of S102 described with reference to FIG. 18.

(Description of Representation)

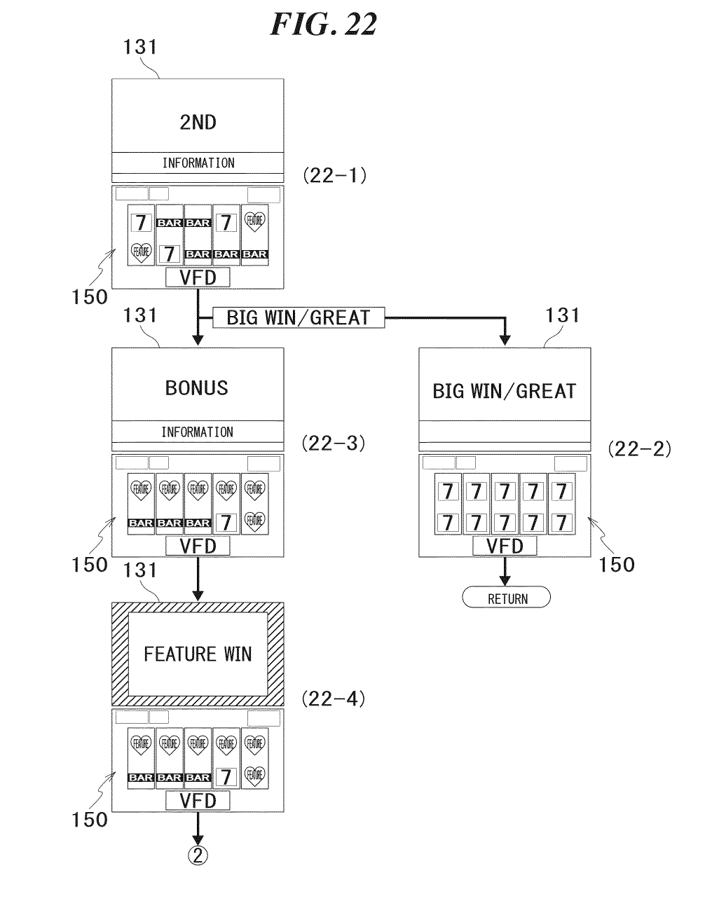

Next, with reference to FIG. 22 to FIG. 31, screen images displayed on the upper image display panel 131 in course of the process described above and the state of entertaining effects in the display window 150 will be described.

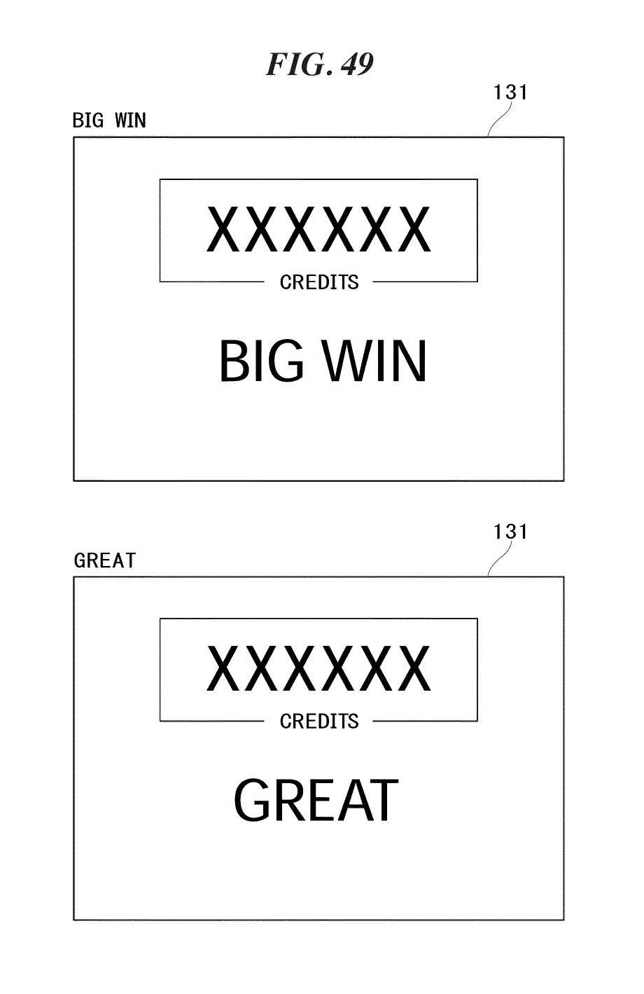

In normal games, as shown in FIG. 22, the symbol arrays of the reels 101 to 105 start to scroll (see FIG. 22: 22-1), and the symbols to be stopped that are determined in the symbol drawing process of the step S14 stop at the predetermined positions (in the middle row region of the display window 150) through the symbol display control process (S16) in the main control process. Consequently, the payouts are awarded in accordance with the combination of symbols appeared on the effective pay lines 1 to 30 (see FIG. 22: 22-2). When a large amount of payout is awarded, as shown in FIG. 49, the upper image display panel 131 displays a “BIG WIN” image and a “GREAT” image.

In contrast, as shown in FIG. 22 (22-3), when five or more “FEATURE” symbols are appeared in the display window 150 and the free game trigger is satisfied, as shown in FIG. 22 (22-4), the upper image display panel 131 displays a “FEATURE WIN” image.

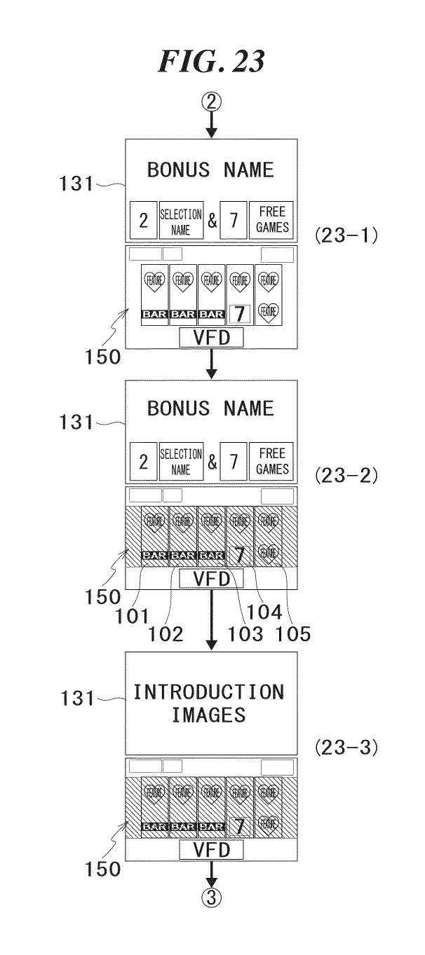

Next, as shown in FIG. 23 (23-1), the upper image display panel 131 displays the number of roulette type selections determined in the process of S202 in a “Selection Name” item and the value of the number-of-free-games counter to which the number of free games awarded in the process of S102 is added in a “Free Games” item.

Next, as shown in FIG. 23 (23-2), the entertaining effect in which the display window 150 is dimmed by shutting the backlights of the reels 101 to 105 off is carried out, and then, as shown in FIG. 23 (23-3), the upper image display panel 131 displays introduction images of free games.

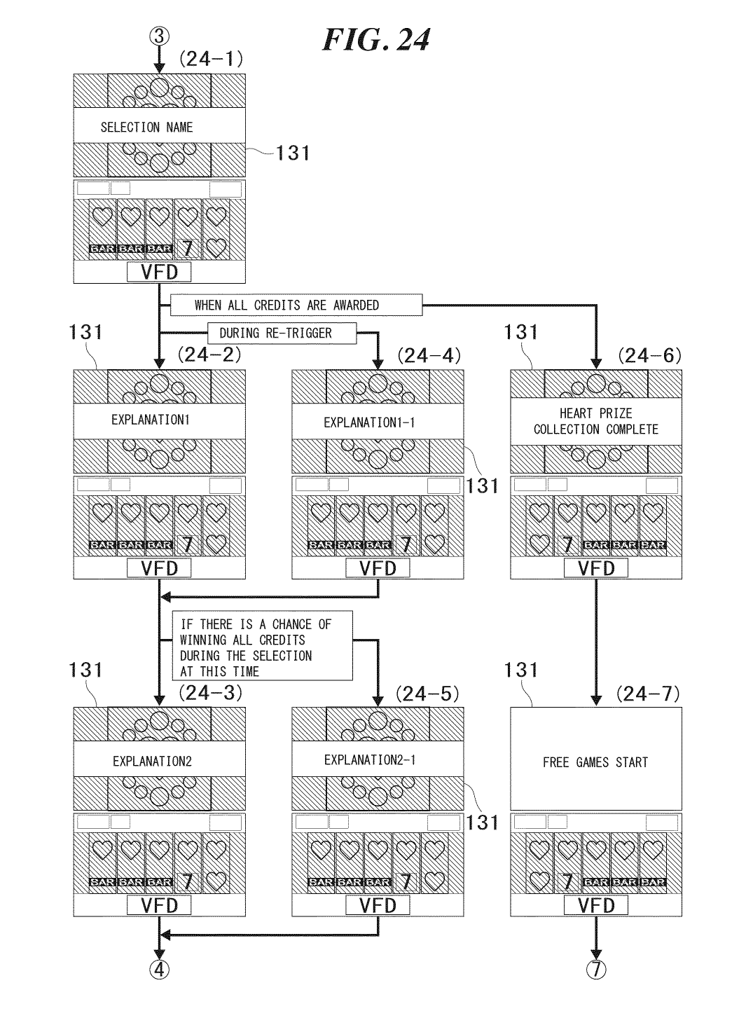

Next, as shown in FIG. 24 (24-1), the upper image display panel 131 displays the number of roulette type selections as the “Selection Name”. Then, the upper image display panel 131 displays the description of the roulette type selection (see FIGS. 24: 24-2 to 24-5). At this time, when the re-trigger is satisfied in the process of S108, the re-trigger is explained (see FIG. 24: 24-4). If there is a chance of winning all the credits during the roulette type selection at that time, such matter is informed and explained (see FIG. 24: 24-5).

In contrast, if all the credits are awarded in the roulette type selection, a message of “Congratulations! You won all HEART PRIZE” is displayed (FIG. 24: 24-6). Then, as shown in FIG. 24 (24-7), the upper image display panel 131 displays a message for informing the start of free games.

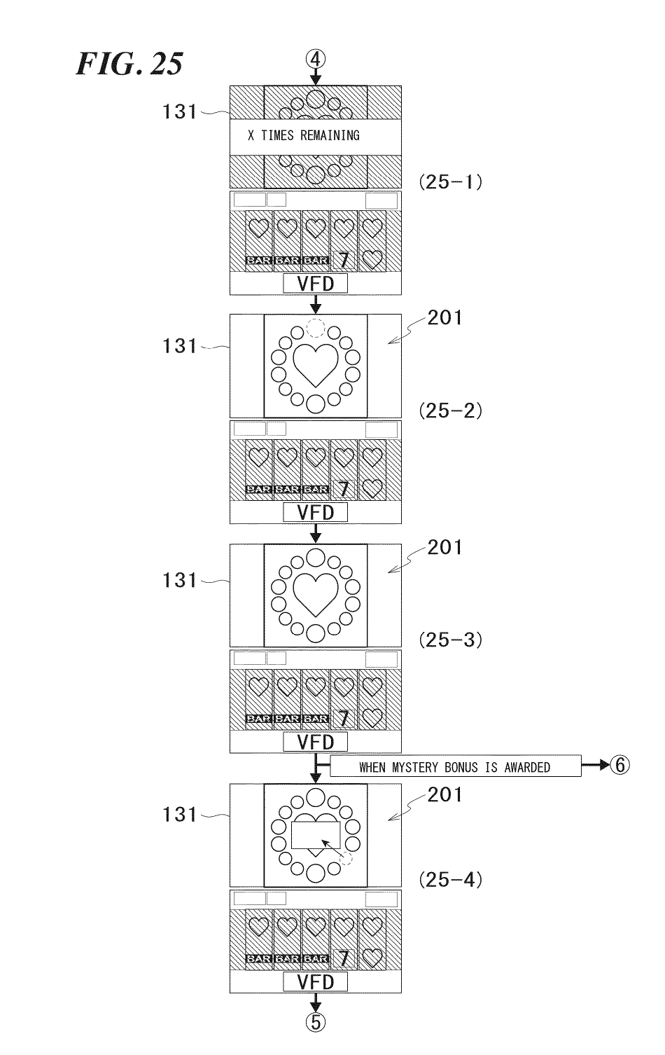

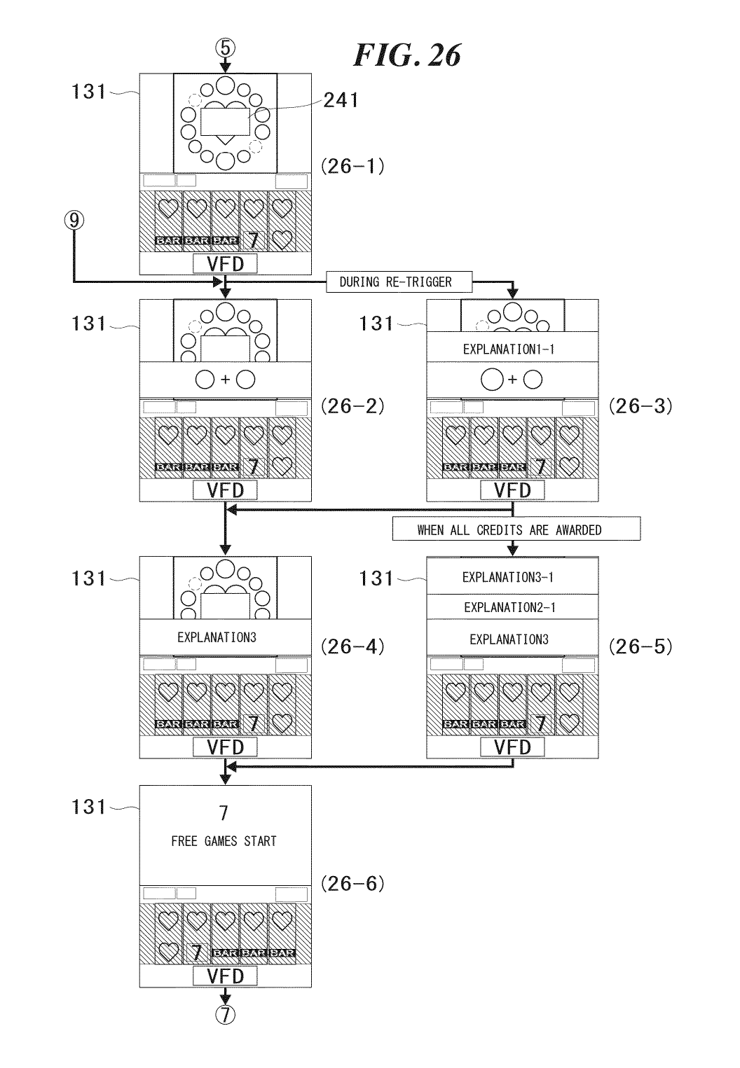

Next, as shown in FIG. 25 (25-1), the upper image display panel 131 displays again the remaining number of roulette type selections. After that, through the roulette display process of S204, a roulette 201 is displayed on the upper image display panel 131 (FIG. 25: 25-2). Through the roulette display control process of S207, the rotation of the roulette 201 is displayed with entertaining effects (FIG. 25: 25-3). After that, when the mark 202 in the roulette 201 stops at the fixed payout region, the payout values associated with the fixed payout region at which the mark stops are displayed (FIG. 25: 25-4), and the entertaining effect in which the value is added to the value displayed on the mystery award sign 241 is carried out (FIG. 26: 26-1).

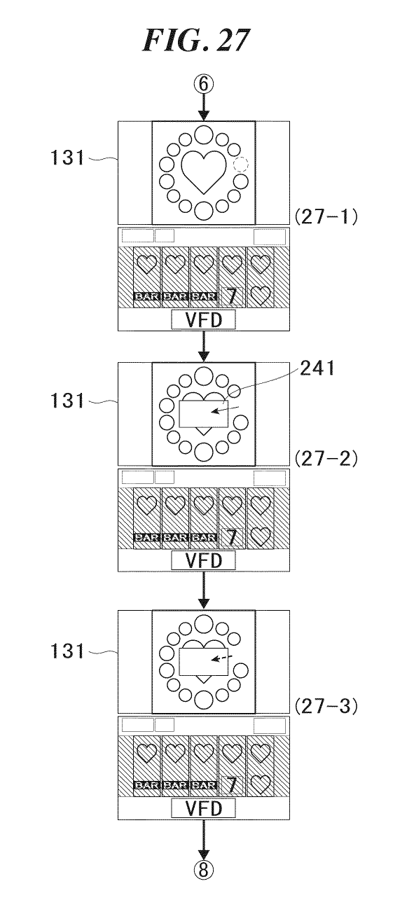

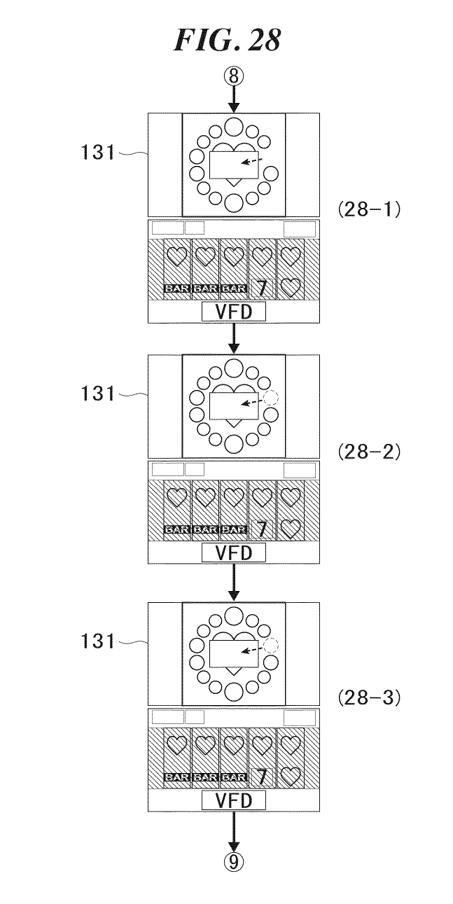

In contrast, when the mark 202 in the roulette 201 stops at the non-fixed payout region (FIG. 27: 27-1), the upper image display panel 131 displays the entertaining effect in which the non-fixed payout region at which the mark stops is enlarged and moves to the heart-shaped mystery award sign 241 at the center (FIG. 27: 27-2). After that, through the mystery payout drawing effect process of S210, the payout values associated with the applicable payout drawing table in FIG. 15A to 15D are displayed by scrolling in order (see FIG. 27: 27-3), and then, as shown in FIG. 47, the payout value corresponding to the determined number in the mystery payout drawing process of S209 is displayed to stop on the meter 242 (see FIG. 28: 28-1). After that, the payout value stopped on the meter 242 is displayed on the mystery award sign 241 (FIG. 28: 28-2), the payout value displayed and stopped on the meter 242 is added to the value stored in the reference payout value storage area, and the entertaining effect in which the total value is displayed on the mystery award sign 241 is carried out (FIG. 28: 28-3).

Next, after the entertaining effects shown in FIG. 26 (26-1) or FIG. 28 (28-3) in the upper image display panel 131, the details of the value stored in the reference payout value storage area are displayed (FIG. 26: 26-2). Specifically, as shown in FIG. 38, the payout values awarded as a result of the number of times in accordance with the number of roulette type selections awarded in the processes of S201 and S202 are separately displayed. For example, when the number of roulette type selections awarded in the processes of S201 and S202 is twice, the display item 261 displays the payout value awarded as a result of the roulette type selection on a first try and the payout value awarded as a result of the roulette type selection on a second try. When the number of roulette type selections awarded in the processes of S201 and S202 is seven times, the display item 261 displays a message of ‘The total of 7 HEART PRIZES won’ (see FIG. 38).

When the re-trigger is satisfied in the process of S108, as shown in FIG. 44, the total of payout values 262 awarded in the first free game trigger is collectively displayed in the display item 261, and the payout values awarded as a result of the number of times in accordance with the number of roulette type selections awarded in the processes of S201 and S202 after the re-trigger is satisfied are separately displayed (see FIG. 26: 26-3). For example, when the number of roulette type selections awarded in the processes of S201 and S202 is twice, the display item 261 displays the total of payout values 262 awarded in the first free game trigger, the payout value 263 awarded as a result of the roulette type selection on the first try, and the payout value 264 awarded as a result of the roulette type selection on the second try (see FIG. 44). When the number of roulette type selections awarded in the processes of S201 and S202 is seven times, the display item 261 displays the total of payout values 262 awarded in the first free game trigger and the message of ‘The total of 7 HEART PRIZES won’ (see FIG. 44).

Next, as shown in FIG. 26 (26-4) or (26-5), the upper image display panel 131 displays the explanation about the reference payout value that is the payout for one “FEATURE” symbol appeared in the display window 150 during the free game. Specifically, as shown in FIG. 38 or FIG. 44, a message of “XX credits awarded each time 1 FEATURE appears during the free games” is displayed. In FIG. 44, when all of the payouts associated with the fixed payout region and the non-fixed payout region of the roulette 201 are displayed, a message of “Congratulations! You won all HEART PRIZE” is displayed.

Next, as shown in FIG. 26 (26-6), the upper image display panel 131 displays a message for informing the start of free games.

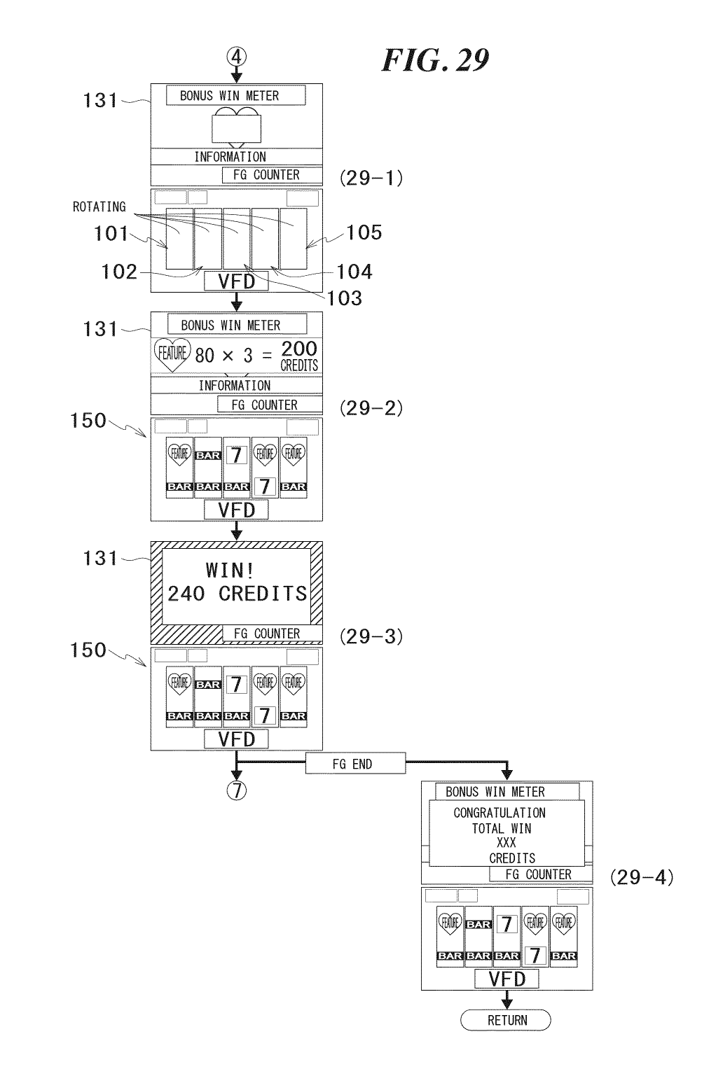

Next, through the symbol display control process (S106) in the free game process, the symbol arrays of the reels 101 to 105 start to scroll (see FIG. 29: 29-1), and the symbols to be stopped that are determined in the symbol drawing process of the step S104 stop at the predetermined positions (in the middle row region of the display window 150) (FIG. 29: 29-2). When the “FEATURE” symbol rearranged in the display window 150 at this time, the upper image display panel 131 displays ‘Reference Payout Value×Number of “FEATURE” symbols=Payouts’ (FIG. 29: 29-2). After that, the upper image display panel 131 displays the awarded payouts as a message of “WIN! XX Credits” (FIG. 29: 29-3).

After that, when it is determined in the process of S113 that the value stored in the number-of-free-games counter is not zero (end of free games), the total of the payouts acquired during the free games are displayed as a “Total Win” as shown in FIG. 29 (29-4).

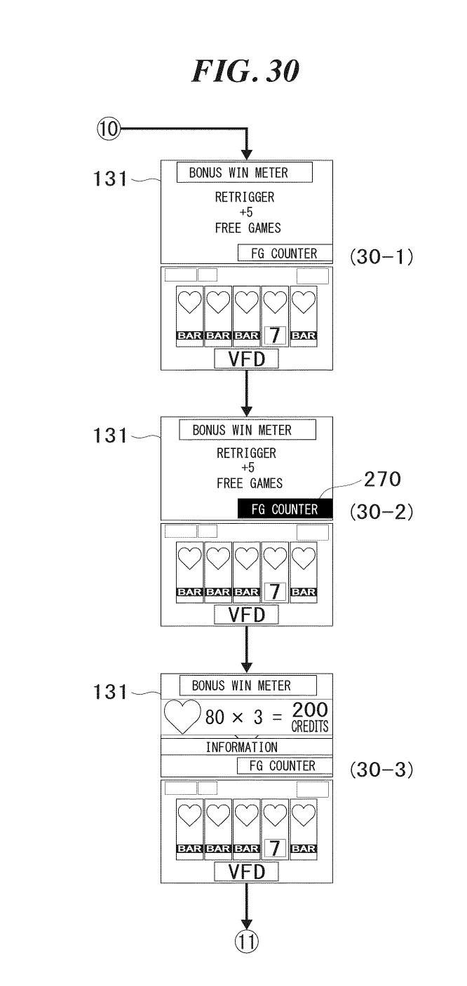

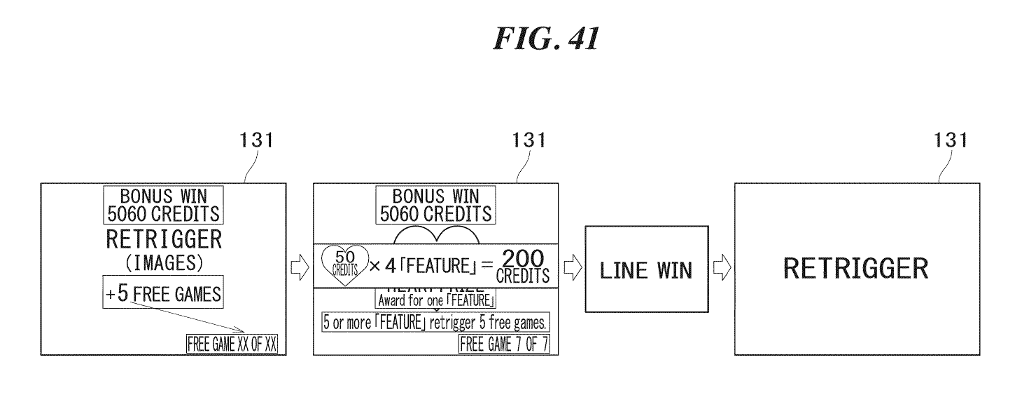

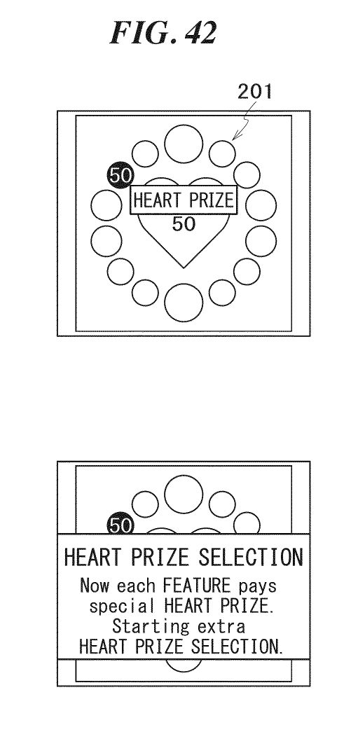

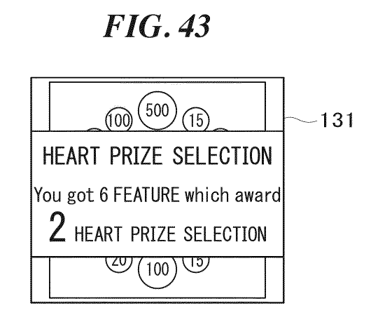

In contrast, in S108 of the free game process, when five or more “FEATURE” symbols are rearranged in the display window 150, this is determined as the re-trigger, and as shown in FIG. 30 (30-1), the upper image display panel 131 displays a message for informing the re-trigger and the number of free games awarded additionally (see FIG. 41). Then, as shown in FIG. 30 (30-2), the number of free games additionally awarded is added to the number of free games displayed in the number-of-free-games counter display 270. During the re-trigger, as shown in FIG. 42 and FIG. 43, the upper image display panel 131 again displays the roulette 201 and the description of the roulette type selection during the re-trigger.

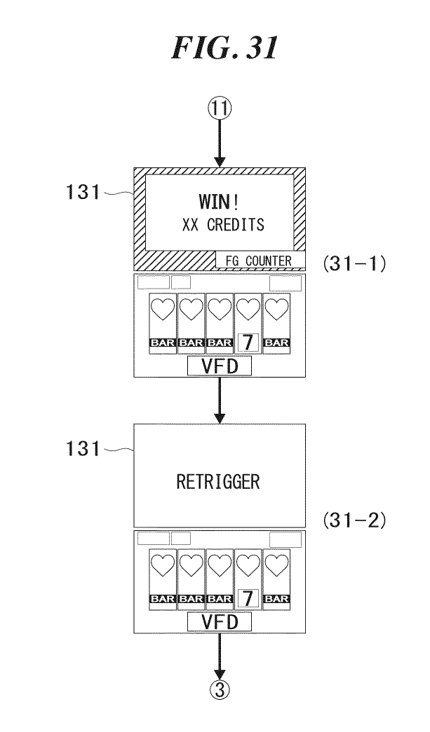

In addition, the “FEATURE” symbols are rearranged in the display window 150, and thus the upper image display panel 131 displays ‘Reference Payout Value×Number of “FEATURE” symbols=Payouts’ (FIG. 30: 30-3). After that, the upper image display panel 131 displays the awarded payouts as a message of “WIN! XX Credits” (FIG. 31: 31-1). Then, the upper image display panel 131 displays the re-trigger (FIG. 31: 31-2).

According to the configuration described above, when the game transfers from the normal game to the free game, the roulette type selection process is carried out for determining the reference payout value (payout for one “FEATURE” symbol appeared in the display window 150) that serves as a basis for the payout awarded when the FEATURE symbols are arranged in the display window 150 during the free game. In this roulette type selection process, it is determined that any of the fixed payout regions associated with the predetermined payout value or the non-fixed payout regions are stopped. When the fixed payout region is determined to be stopped, the payout value associated with the fixed payout region is awarded. When the non-fixed payout region is determined to be stopped, the mystery payout drawing process in which the awarded payout value is determined at random is additionally performed, and thus the payout value determined through the payout drawing is awarded. Then, the payout value awarded as described above is set as the reference payout value. The reference payout value in the free game is accordingly determined in two-step drawing of the roulette type selection process and the mystery payout drawing process, and thus the player can enjoy the game with interest in the determination process of the reference payout value and the entertaining effects during the free games.

According to the configuration described above, the number of executing the roulette type selection process can be determined, depending on the number of “FEATURE” symbols arranged in the display window 150 during the normal games or the free games, and the sum total of the payout value awarded in accordance with the results of the roulette type selection process for the number of times determined can be set as the reference payout value. Thus, the player can enjoy the game with interest in the result of every roulette type selection process.

When the sum total of the payout value awarded in accordance with the results of a plurality of the roulette type selection processes can be set as the reference payout value, how many times the player can draw the roulette type selection is major concern for the player. According to the configuration described above, the reels 101 to 105 execute the number of roulette type selection processes depending on the number of FEATURE symbols rearranged in the display window 150, and thus the player can enjoy the game with interest in which kind of symbols are rearranged in display window 150.

When the result of the free game is the re-trigger, the roulette type selection process can be carried out again, and furthermore, the payout value awarded as a result can be added to the reference payout value. Thus, the player can enjoy the game with interest in whether the re-trigger is awarded even in the free games or not.

When the game transfers from the normal game to the free game, the MYSTERY position determination process is performed for determining the table code in a drawing on the basis of the non-fixed payout region transfer table, and four payout drawing tables (MYSTERY1 to 4) can be associated with four non-fixed payout regions (“No. 2: MYSTERY”, “No. 5: MYSTERY”, “No. 9: MYSTERY”, “No. 12: MYSTERY”) in accordance with the determined table code. Four payout drawing tables that include different payout values and winning rates can be associated with the non-fixed payout regions in a drawing, accordingly. Thus, the payout value and winning rate for the non-fixed payout region in the mystery payout drawing process are changed each time the game transfers from the normal game to the free game, and the player can enjoy the game with non-uniform payout value and winning rate for the non-fixed payout region and changing each time.

While the embodiments of the present invention have been described so far, only concrete examples are described. The present invention is not particularly limited to those examples, and specific configurations of means and the like may appropriately be changed in design. In addition, the effects described in the embodiments of the present invention are only enumerated for most preferable effects provided from the present invention, and the effects by the present invention are not limited to those described in the embodiments of the present invention.

In the detailed descriptions stated above, distinctive features are mainly described for easy understanding of the present invention. The present invention is not limited to the embodiments described in the detailed descriptions stated above and applicable to other embodiments, and the scope of the present invention varies widely. Terms and wording used herein are only used for describing the present invention accurately and not intended to limit the interpretation of the present invention. It is easily recognized by the person ordinarily skilled in the art that other configuration, system, and methods included in the concept of the present invention can be derived from the concepts of the present invention disclosed herein. Therefore, the descriptions of the claims should be considered as including an equivalent configuration within a range not departing from the technical ideas of the present invention. The object of the abstract is to provide a material in which an engineer and other persons who are not acquainted with the Patent Office and general public institution and patent, law, or technical terms but belong to this technical field can evaluate the technical details and the nature of the present application promptly with a simple research. Therefore, the abstract is not intended to limit the scope of the invention to be evaluated by the descriptions of the claims. In order to fully understand the objects and the specific effects of the present invention, it is desired to construe the present invention by fully considering the disclosed documents and the like.

The detailed description stated above includes the processes executed on computers. The above description and expression are stated in order that the person ordinarily skilled in the art can understand the invention in the most efficient ways. In this specification, each process used for leading one result should be understood as the process without a contradiction. In each process, electrical or magnetic transmission, recording of signals, and other processes are conducted. For processing in each process, such signals are expressed with a bit, value, symbol, character, word, number, and the like; however, it should be noted that these are merely used for ease of explanation. Although the processing in each process may be written by the expression in common with human behaviors, the processing described herein are conducted by various devices in principle. Furthermore, other configuration required for conducting each processing becomes obvious upon the above descriptions.

### REFERENCE SIGNS LIST

1 Slot machine
71 Main CPU 71 (Controller)
M1 Reel device (Display device)
71 Main CPU
73 RAM
101 to 105 Reel
131 Upper image display panel
150 Display window

What is claimed is:

1. A gaming machine for executing a normal game and a free game triggered from the normal game,
the gaming machine comprising:
a display device; and
a controller,
wherein the controller executes the following processes:
(1A) a process of executing the normal game and awarding a prize in accordance with a result of the normal game;
(1B) a process of displaying a roulette having a plurality of fixed payout regions associated with predetermined payout values and a plurality of non-fixed payout regions on the display device when the prize awarded in the process of (1A) is an execution right of the free game;
(1C) a process of performing a roulette type selection that determines at which of the fixed payout region and the non-fixed payout region a mark indicating a winning in the roulette stops;
(1D) a process of awarding, as a result of the roulette type selection,
a payout value associated with the fixed payout region when the region where the mark stops is the fixed payout region, and
a payout value determined through a payout drawing that is carried out for determining the awarded payout value at random when the region where the mark stops is the non-fixed payout region; and
(1E) a process of executing the free game, when a predetermined condition is satisfied as a result of the free game, setting the payout values awarded in the process of (1D) as a reference payout value, and awarding a payout on a basis of the reference payout value.

2. The gaming machine according to claim 1,
wherein the controller
performs the number of the roulette type selections depending on the condition when the prize awarded in the process of (1A) is the execution right of the free game and the condition in which a plurality of the roulette type selections can be performed is satisfied, and
determines a sum total of the payout values awarded in accordance with the results of the plurality of the roulette type selections in the process of (1E) as the reference payout value and awards the payout based on the reference payout value.

3. The gaming machine according to claim 2,
wherein the gaming machine
includes a symbol display device for displaying the results of the normal game and the free game by rearranging the plurality of symbols,
wherein the condition in which the plurality of the roulette type selections can be performed is rearrangement of the predetermined number of predetermined symbols in the symbol display device as the results of the normal game and the free game, and
the controller executes the number of the roulette type selections depending on the number of the predetermined symbols rearranged in the symbol display device.

4. The gaming machine according to claim 1,
wherein the controller
executes the roulette type selection again when the prize awarded in the free game as a result of the free game is a re-execution right of the free game, adds the payout value awarded as a result of the roulette type selection to the reference payout value, and executes a process to update the reference payout value.

5. A gaming machine for executing a normal game and a free game triggered from the normal game,
the gaming machine comprising:
a roulette type selection table that associating region numbers arranged in a roulette, a plurality of fixed payout regions associated with predetermined payout values, a plurality of non-fixed payout regions, and winning rates;
a plurality of payout drawing tables that include different payout values and winning rates;
a storage device for storing a plurality of table codes, the region number corresponding to the plurality of non-fixed payout regions, and a non-fixed payout region transfer table associated with the plurality of payout drawing tables and winning rates;
a display device; and
a controller,
wherein the controller executes the following processes:
(2A) a process of executing the normal game and awarding a prize in accordance with a result of the normal game;
(2B) a process of performing a non-fixed payout region transfer drawing that determines the table code in a drawing in accordance with the non-fixed payout region transfer table and determining the payout drawing table corresponding to the plurality of non-fixed payout regions in accordance with the determined table code, when the prize awarded in the process of (2A) is an execution right of the free game;
(2C) a process of displaying in the display device a roulette in which the region numbers associated with the fixed payout regions and the plurality of non-fixed payout regions are arranged, in accordance with a result of the non-fixed payout region transfer drawing;
(2D) a process of performing a roulette type selection for determining at which of the region numbers a mark indicating a winning in the roulette stops in accordance with the roulette type selection table;
(2E) a process of awarding, as a result of the roulette type selection,
a payout value associated with the fixed payout region when the region number where the mark stops is the fixed payout region, and
a payout value determined through a payout drawing that is carried out for determining the awarded payout value at random in accordance with the payout drawing table corresponding to the non-fixed payout region when the region number where the mark stops is the non-fixed payout region; and
(2F) a process of executing the free game, when a predetermined condition is satisfied as a result of the free game, setting the payout values awarded in the process of (2E) as a reference payout value, and awarding the payout on a basis of the reference payout value.

6. A method of controlling a gaming machine for executing a normal game and a free game triggered from the normal game,
wherein the gaming machine includes:
a display device; and
a controller,
the method of controlling the gaming machine comprising the steps of, wherein the steps are executed through the controller:
(3A) executing the normal game and awarding a prize in accordance with a result of the normal game;
(3B) displaying a roulette having a plurality of fixed payout regions associated with predetermined payout values and a plurality of non-fixed payout regions on the display device when the prize awarded in the step of (3A) is an execution right of the free game;
(3C) performing a roulette type selection that determines at which of the fixed payout region and the non-fixed payout region a mark indicating a winning in the roulette stops;
(3D) awarding, as a result of the roulette type selection,
a payout value associated with the fixed payout region when the region where the mark stops is the fixed payout region, and
a payout value determined through a payout drawing that is carried out for determining the awarded payout value at random when the region where the mark stops is the non-fixed payout region; and
(3E) executing the free game, when a predetermined condition is satisfied as a result of the free game, setting the payout values awarded in the step of (3D) as a reference payout value, and awarding the payout on a basis of the reference payout value.
